(19) United States
(12) Patent Application Publication
(10) Pub. No.: US 2016/0004917 A1
(43) Pub. Date: Jan. 7, 2016

(54) OUTPUT CONTROL METHOD, IMAGE PROCESSING APPARATUS, AND INFORMATION PROCESSING APPARATUS

(71) Applicant: FUJITSU LIMITED, Kawasaki-shi (JP)

(72) Inventor: Toshikuni Yoshida, Kawasaki (JP)

(21) Appl. No.: 14/736,376

(22) Filed: Jun. 11, 2015

(30) Foreign Application Priority Data
Jul. 1, 2014 (JP) 2014-135911

(51) Int. Cl. G06K 9/00; G06T 15/10

(52) U.S. Cl. CPC G06K 9/00885; G06T 15/10; G06K 2009/00932

(57) ABSTRACT

A storage unit stores a first biometric image of a living body obtained with a second imaging method in association with biometric information of the living body obtained with a first imaging method. When determining that biometric information of a certain living body obtained with the first imaging method corresponds to the biometric information stored in the storage unit, a display control unit superimposes and displays part or the whole of the first biometric image on a second biometric image of the certain living body obtained with a third imaging method.

### CROSS-REFERENCE TO RELATED APPLICATION

This application is based upon and claims the benefit of priority of the prior Japanese Patent Application No. 2014-135911, filed on Jul. 1, 2014, the entire contents of which are incorporated herein by reference.

### FIELD

The embodiments discussed herein relate to an output control method, an image processing apparatus, and an information processing apparatus.

### BACKGROUND

On the medical frontline, some techniques are used to assist doctors in surgery. For example, there is a proposal to obtain a map that defines the distribution of values of a physiological parameter over a whole organ (for example, the distribution of local electrical potentials across the entire inner surface of the heart), and to display the map together with a three-dimensional image of the organ. In this proposal, the values of the physiological parameter are superimposed onto the three-dimensional image with geometrical transformation using an anatomical landmark external to the organ, and the superimposed values and three-dimensional image are displayed.

Further, there is another proposal where a trocar, into which an endoscope or other surgical tools are inserted, is equipped with a sensor for detecting data such as an angle of the trocar when the trocar is inserted in the abdominal area, and virtual image data is generated on the basis of the results detected by the sensor. Still further, there is yet another proposal where a virtual image corresponding to an endoscopic image, which varies in real time, is displayed on a virtual image monitor, and, for example, in the case where an organ is resected, a marking image for the resection surface is superimposed onto the virtual image according to a surgeon's instruction that is made based on the progress of the procedure.

Please see, for example, Japanese Laid-open Patent Publications Nos. 2007-268259, 2005-211531, and 2005-278888.

### SUMMARY

According to one aspect, there is provided an output control method, which includes: acquiring a captured biometric image; and outputting, by a computer, upon detecting that the acquired biometric image corresponds to biometric information of a specific body part of a specific living body, medical information registered in association with the specific body part of the specific living body.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an image processing apparatus according to a first embodiment;

FIG. 2 illustrates an example of an image processing system according to a second embodiment;

FIG. 3 illustrates an example of a hardware configuration of the image processing apparatus according to the embodiment;

FIG. 4 illustrates an example of functions of the image processing apparatus;

FIG. 5 illustrates an example of a medical image table;

FIG. 6 illustrates an example of a vein pattern profile;

FIG. 7 illustrates an example of a vein pattern profile table;

FIG. 8 illustrates how to compare vein pattern profiles;

FIG. 9 illustrates an example of a video frame buffer;

FIG. 10 is a flowchart illustrating an example of how to register a medical image;

FIG. 11 illustrates an example of placement of a virtual camera with respect to a three-dimensional model;

FIGS. 12 and 13 illustrate first and second examples of capturing a vein pattern.

FIG. 14 is a flowchart illustrating an example of image processing;

FIGS. 15A to 15C illustrate an example of captured images;

FIG. 16 illustrates an example of analyzing a vein pattern;

FIG. 17 illustrates an example of the coordinates of feature points;

FIGS. 18A and 18B illustrate examples of a bounding box;

FIG. 19 illustrates an example of obtaining parameters for image transformation;

FIG. 20 illustrates an example of image transformation of a medical image;

FIGS. 21 and 22 illustrate first and second examples of another image processing system; and

FIGS. 23 to 27 illustrate first to fifth examples of display.

### DESCRIPTION OF EMBODIMENTS

It is considered that medical information (for example, information about blood vessels hidden behind an organ or an affected focus) is superimposed and displayed on an operative field on a monitor or the like, so as to complement surgeon's visual information. Since the arrangement of organs and focuses differs depending on patients and organs, medical information is managed for a great number of patients. In addition, medical information on various organs may be managed for each patient. If different medical information is output by mistake (for example, if medical images of another patient or another organ are output), surgery may be impeded. To deal with this, it needs to be considered how to implement a mechanism for outputting proper medical information for an operative field.

Several embodiments will be described below with reference to the accompanying drawings, wherein like reference numerals refer to like elements throughout.

### First Embodiment

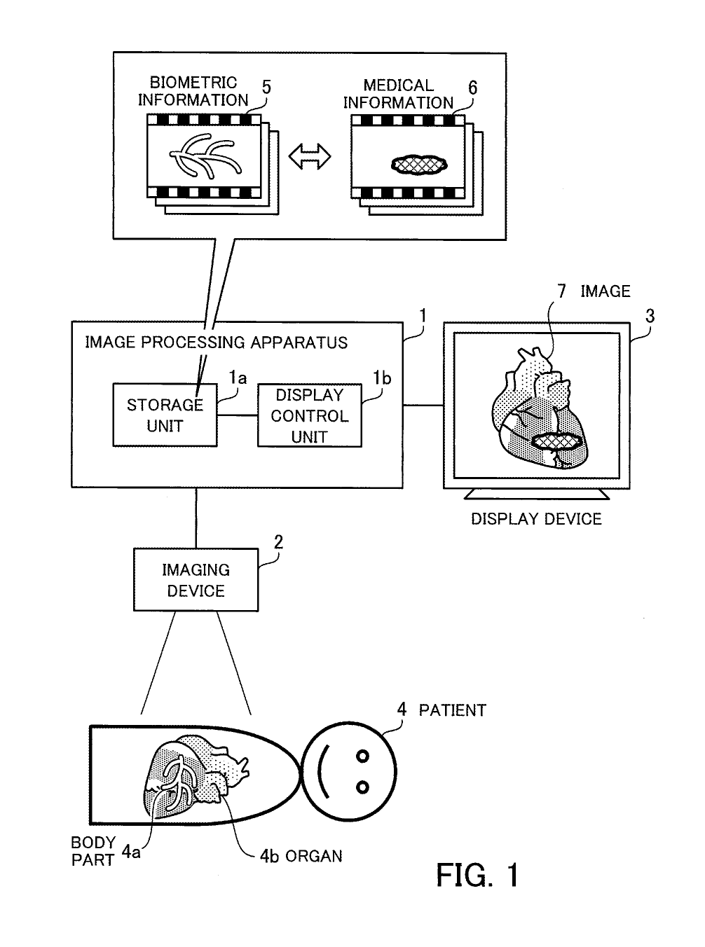

FIG. 1 illustrates an image processing apparatus according to a first embodiment. An image processing apparatus 1 generates image information by superimposing medical information on an image of a living body. For example, the image processing apparatus 1 is used to assist doctors in surgery. The image processing apparatus 1 is connected to an imaging device 2 and a display device 3. The imaging device 2 captures images of a living body. The display device 3 displays an image based on the image information received from the image processing apparatus 1.

The image processing apparatus 1 includes a storage unit 1a and a display control unit 1b. The storage unit 1a may be a volatile storage device, such as a Random Access Memory (RAM), or a non-volatile storage device, such as a Hard Disk Drive (HDD) or a flash memory. The display control unit 1b may include a Central Processing Unit (CPU), a Digital Signal Processor (DSP), an Application Specific Integrated Circuit (ASIC), a Field Programmable Gate Array (FPGA), or others. The display control unit 1b may be a processor that runs programs. The “processor” here may be a plurality of processors (multiprocessor).

The storage unit 1a stores a plurality of pieces of biometric information and a plurality of pieces of medical information. The storage unit 1a stores the biometric information and the medical information in association with each other. One piece of the biometric information may be associated with a plurality of pieces of the medical information. The biometric information represents a body part of a living body. For example, the biometric information may be information about a vein pattern (for example, information representing the features of a vein pattern). The storage unit 1a may store biometric information corresponding to a plurality of body parts for one living body. The medical information is used for visually assisting doctors in surgery. The medical information may be information about an image representing blood vessels hidden behind an organ, an affected focus inside or outside the organ, or others.

For example, the storage unit 1a stores a plurality of pieces of biometric information and a plurality of pieces of medical information obtained in advance. As one piece of the biometric information, the storage unit 1a stores a biometric record 5 representing a body part 4a of a patient 4. As one piece of the medical information, the storage unit 1a stores a medical record 6 representing an image of a focus in an organ 4b. The storage unit 1a stores the biometric record 5 and the medical record 6 in association with each other.

The biometric record 5 and the medical record 6 are obtained with a prescribed imaging method before surgery and are then stored in the storage unit 1a. For example, before surgery, the image processing apparatus obtains a three-dimensional model of focuses on the surface of or inside the organ 4b or other organs in the vicinity of the organ 4b of the patient 4, organs, blood vessels, and others with the Computed Tomography (CT), the Magnetic Resonance Imaging (MRI), the angiography, or another method. The image processing apparatus 1 then obtains, from the three-dimensional model, the medical record 6 representing an image of a focus on the surface of or inside the organ 4b, an image of another organ or blood vessels in the vicinity of the organ 4b, or another image.

At this time, for example, it is considered that the image processing apparatus 1 obtains the biometric record 5 representing a vein pattern near the body surface with a near-infrared camera, which captures images using near-infrared light, and stores the biometric record 5 and the medical record 6 in association with each other in the storage unit 1a.

More specifically, the image processing apparatus 1 obtains, as the biometric record 5, information about a vein pattern near the body surface, captured using near-infrared light by the near-infrared camera which is located at a prescribed position outside the body of the patient 4 and whose imaging surface faces the organ 4b inside the body. The image processing apparatus 1 stores the biometric record 5 in association with the medical record 6 (medical information obtained from a three-dimensional model) representing an image of a focus or others viewed from the same direction in the storage unit 1a. For example, the image capturing using near-infrared light may be called a first imaging method. In addition, the capturing of a medical image from a three-dimensional model may be called a second imaging method.

Alternatively, the image processing apparatus 1 may be able to capture an image of a vein pattern with the angiography or another method. That is to say, the image processing apparatus 1 may obtain the biometric record 5 representing a vein pattern deep inside the patient 4 from the above-described three-dimensional model. For example, the image processing apparatus 1 may obtain information about a vein pattern in the vicinity of a focus represented by the medical record 6, from the three-dimensional model. The information stored in the storage unit 1a is used for controlling the output of medical information as described below.

The display control unit 1b acquires a captured biometric image. It may be considered that the display control unit 1b includes an acquisition unit that implements the acquisition function. When detecting that the acquired biometric image corresponds to biometric information of a specific body part of a specific living body, the display control unit 1b outputs the medical information stored in association with the specific body part of the specific living body in the storage unit 1a. It may be considered that the display control unit 1b includes an output processing unit that implements the output function.

For example, the display control unit 1b acquires a biometric image captured by the imaging device 2 using visible light during surgery of the patient 4. The image capturing using visible light may be called a third imaging method. In addition, the display control unit 1b obtains information about a vein pattern captured using near-infrared light. The display control unit 1b compares the obtained information about the vein pattern with a plurality of pieces of biometric information (registered information about vein patterns) registered in advance in the storage unit 1a to detect that the acquired biometric image corresponds to biometric information of a specific body part of a specific living body. For example, when detecting that information about a vein pattern acquired during surgery matches the biometric record 5, the display control unit 1b outputs the medical record 6 registered in association with the biometric record 5 in the storage unit 1a.

The display control unit 1b outputs the medical record 6 in association with the captured biometric image or a separately captured biometric image to the display device 3. More specifically, the display control unit 1b generates image information by superimposing the medical record 6 onto the biometric image and outputs the image information to the display device 3. The display device 3 displays an image 7 based on the image information received from the display control unit 1b. The image 7 includes the image represented in the medical record 6. By displaying the image 7, the display control unit 1b enables a doctor to recognize the positions of a focus in an organ, blood vessels inside and outside the organ, other organs in the vicinity of the organ, and others.

As described above, the image processing apparatus 1 acquires a captured biometric image. When detecting that the acquired biometric image corresponds to the biometric record 5 of the specific body part 4a of the specific living body, the image processing apparatus 1 outputs the medical record 6 registered in association with the specific body part 4a (that is, biometric record 5) of the specific living body. The medical record 6 is then superimposed and displayed on the biometric image.

By the way, it is considered that the identification code of a patient, represented by a character string, and the medical record 6 are stored in association with each other in the storage unit 1a. In this case, however, entering a different identification code in the image processing apparatus 1 by mistake leads to outputting medical information of a different patient or a different organ. In addition, if identification codes are not properly managed for each patient or each organ, medical information of a different patient or a different organ may be output. Such an erroneous output of medical information may cause medical malpractice.

To deal with these, the image processing apparatus 1 outputs medical information corresponding to a body part that is authenticated through biometrics authentication using biometric information. Biometric information is unique to a living body. Therefore, a living body is properly identified using such biometric information, rather than using other kinds of information such as identification codes. In addition, since there is no need of creating new information such as identification codes by human work, mistakes are not likely to occur. Therefore, the above-described image processing apparatus 1 is able to output proper medical information for a patient's organ that is to be subjected to surgery, for example.

Information about vein patterns may be used as biometric information. Since every single vein pattern has a unique profile, the vein patterns are usable for identifying organs. In addition, by registering organ images (medical information) captured from all 360-degree directions and information about their vein patterns in association with each other in the storage unit 1a, it becomes possible to output medical information corresponding to the direction from which the imaging device 2 captures an image of the organ. As described earlier, when obtaining medical information, the image processing apparatus 1 is able to easily obtain information about a vein pattern with a camera that captures images using near-infrared light, the angiography, or another method. In addition, the image processing apparatus 1 is able to easily obtain information about the vein pattern of an operative field with the camera, even during surgery.

Further, it is also considered to use information about a vein pattern to perform alignment for superimposing medical information onto image information (in this case, information indicating a relative positional relationship between the biometric record 5 and the medical record 6 is also stored in the storage unit 1a). For example, a method is considered which places a reference point (a mark) on an operative field for measuring a position for alignment. This method, however, needs some labor to mark the operative field. By contrast, the use of information about a vein pattern for the alignment eliminates the need of the previous marking on the operative field. This alleviates the burden on patients and reduces doctors' work. In addition, the use of information about vein patterns achieves the alignment with high accuracy, rather than using man-made marks. As a result, it is possible to provide more appropriate assistance for surgery or other procedures.

### Second Embodiment

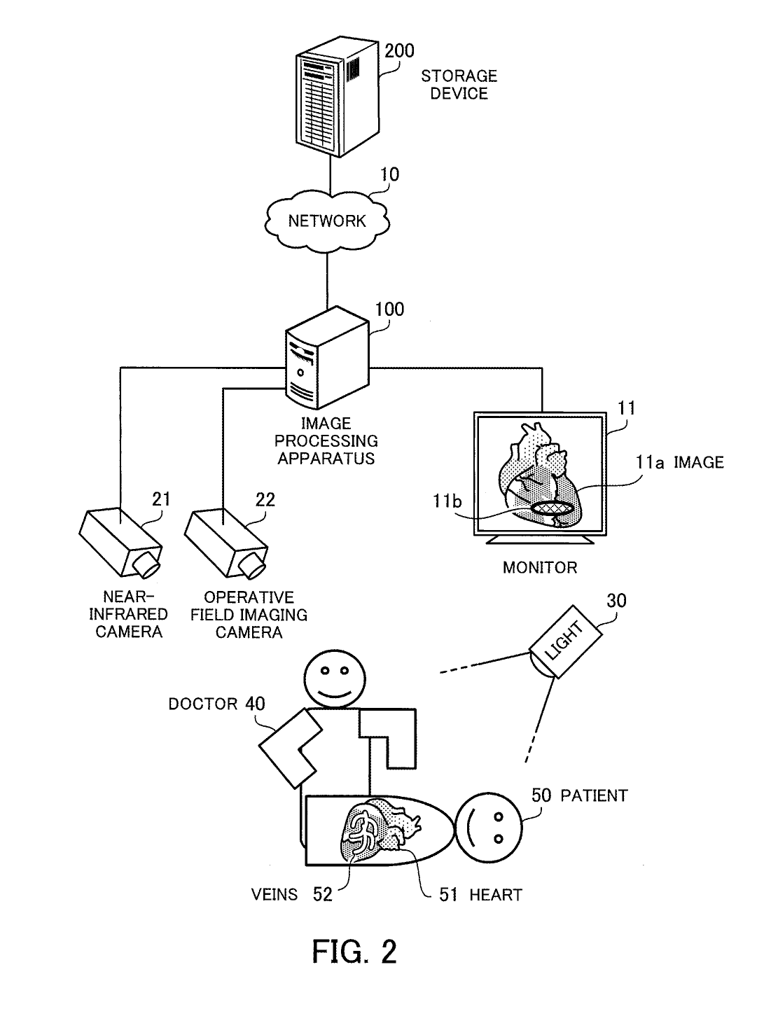

FIG. 2 illustrates an example of an image processing system according to a second embodiment. An image processing system of the second embodiment is installed in a medical facility, such as a hospital or clinic, and assists doctors in surgery. The image processing system of the second embodiment includes an image processing apparatus 100 and a storage device 200. The image processing apparatus 100 and the storage device 200 are connected to a network 10, which is a Local Area Network (LAN), for example.

The image processing apparatus 100 is connected to a monitor 11, a near-infrared camera 21, and an operative field imaging camera 22. The monitor 11 is a display device for displaying images based on image information output from the image processing apparatus 100. The near-infrared camera 21 is an imaging device for capturing images of an operative field using near-infrared light during surgery. The operative field imaging camera 22 is an imaging device for capturing images of the operative field using visible light during surgery. The near-infrared camera 21 and operative field imaging camera 22 may be implemented by using a single camera. For example, it is considered to install a single camera equipped with a filter that selects which light to allow to pass through, and to capture images while switching between the near-infrared light imaging and the visible light imaging.

A light 30 emits visible light or near-infrared light to an operative field. For example, considering that a doctor 40 performs surgery on a patient 50, the operative field includes an open area and its surrounding area. If the surgery is performed on the heart 51 of the patient 50, the heart 51 and its surrounding area are considered as an operative field. Before the skin is incised, the area to be cut on the skin and its surrounding area are considered as an operative field. Veins 52 of the patient 50 are also included in the operative field. For example, the veins 52 are the ones in the heart 51 or the ones in organs in vicinity of the heart 51. Before the skin is incised, veins under the skin are considered as the veins 52.

The near-infrared camera 21 senses near-infrared light emitted by the light 30 and reflected from the operative field, and captures an image. The near-infrared camera 21 generates the image information of the veins 52 through the image capturing and outputs the image information to the image processing apparatus 100. The operative field imaging camera 22 senses visible light emitted by the light 30 and reflected from the operative field, and captures an image. The operative field imaging camera 22 generates the image information of the operative field through the image capturing and outputs the image information to the image processing apparatus 100.

The image processing apparatus 100 is a computer that performs image processing on image information obtained from the near-infrared camera 21 and image information obtained from the operative field imaging camera 22. The image processing apparatus 100 obtains medical information from the storage device 200 on the basis of the image information obtained from the near-infrared camera 21. As an example of the medical information, information about an image of a focus or an organ in the vicinity of an affected area is considered. In the following description, images as one example of the medical information may be called medical images. The image processing apparatus 100 generates image information by superimposing a medical image onto image information obtained from the operative field imaging camera 22 and outputs the image information to the monitor 11. An image processing technique for superimposing and displaying an image on another image currently captured may be called Augmented Reality (AR).

The monitor 11 displays an image 11a based on image information obtained from the image processing apparatus 100. The image 11a includes a medical image 11b representing a focus in the heart 51, for example. The doctor 40 is able to recognize the position of the focus in the heart 51 by viewing the medical image 11b. The following describes how such an image processing system operates.

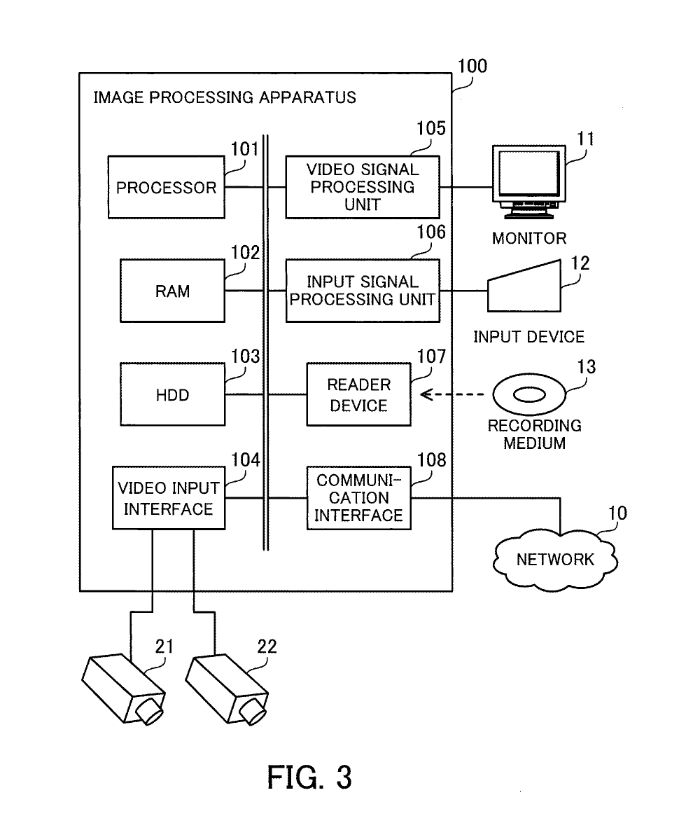

FIG. 3 illustrates an example of a hardware configuration of the image processing apparatus according to the embodiment. The image processing apparatus 100 includes a processor 101, a RAM 102, an HDD 103, a video input interface 104, a video signal processing unit 105, an input signal processing unit 106, a reader device 107, and a communication interface 108. Each of these units is connected to a bus in the image processing apparatus 100.

The processor 101 controls information processing performed by the image processing apparatus 100. The processor 101 may be a multiprocessor. The processor 101 may be, for example, a CPU, a DSP, an ASIC, an FPGA, or others. The processor 101 may be a combination of two or more selected from a CPU, a DSP, an ASIC, an FPGA, and others.

The RAM 102 is a primary storage device of the image processing apparatus 100. The RAM 102 temporarily stores at least part of Operating System (OS) programs and application programs to be executed by the processor 101. The RAM 102 also stores various data that the processor 101 uses in processing.

The HDD 103 is a secondary storage device of the image processing apparatus 100. The HDD 103 writes and reads data magnetically on a built-in magnetic disk. The HDD 103 stores OS programs, application programs, and various data. The image processing apparatus 100 may be equipped with another kind of secondary storage device, such as a flash memory or a Solid State Drive (SSD), or with a plurality of secondary storage devices.

The video input interface 104 has connections with the near-infrared camera 21 and operative field imaging camera 22. The video input interface 104 receives image information captured by the near-infrared camera 21 and operative field imaging camera 22 therefrom and stores the image information in the RAM 102 or HDD 103.

The video signal processing unit 105 outputs images to the monitor 11 connected to the image processing apparatus 100 in accordance with instructions from the processor 101. As the monitor 11, a Cathode Ray Tube (CRT) display, a crystal liquid display, or another display may be used. Alternatively, the video signal processing unit 105 is able to output images to a projector, which projects images on a screen or the like, as will be described later.

The input signal processing unit 106 transfers input signals received from an input device 12 connected to the image processing apparatus 100, to the processor 101. As the input device 12, a pointing device, such as a mouse or a touch panel, a keyboard, or the like may be used.

The reader device 107 reads programs or data from a recording medium 13. As the recording medium 13, for example, a magnetic disk, such as a Flexible Disk (FD) or an HDD, an optical disc, such as a Compact Disc (CD) or a Digital Versatile Disc (DVD), or a Magneto-Optical disk (MO) may be used. In addition, as the recording medium 13, for example, a non-volatile semiconductor memory, such as a flash memory card, may be used. The reader device 107 stores programs and data read from the recording medium 13 in the RAM 102 or HDD 103 in accordance with, for example, instructions from the processor 101.

The communication interface 108 performs communication with other apparatuses over the network 10. The communication interface 108 may be a wired communication interface or a wireless communication interface.

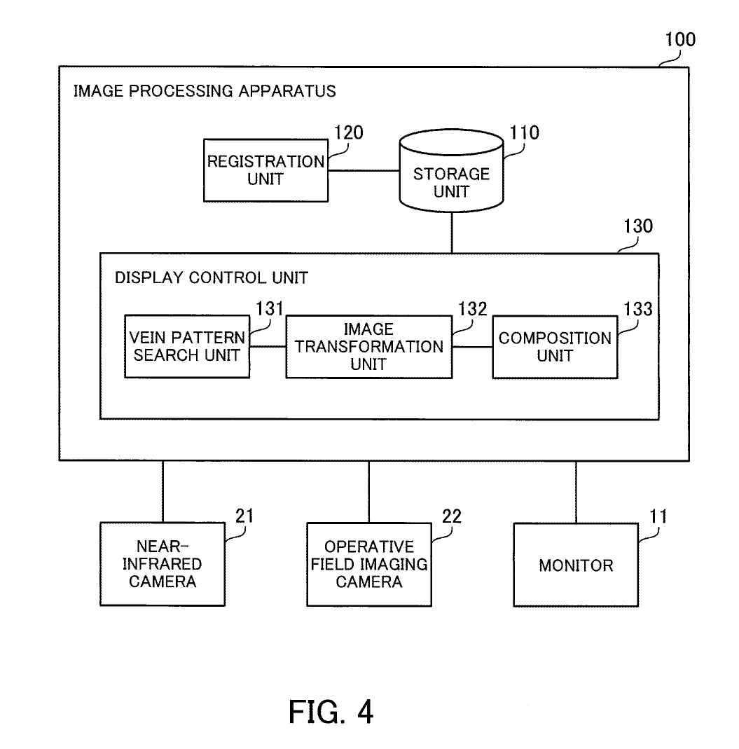

FIG. 4 illustrates an example of functions of the image processing apparatus. The image processing apparatus 100 includes a storage unit 110, a registration unit 120, and a display control unit 130. The registration unit 120 and display control unit 130 may be implemented by the processor 101 executing intended programs.

The storage unit 110 stores information including a medical image table, a video frame buffer, and a vein pattern profile table. The storage unit 110 may be implemented as part of storage space of the RAM 102 or HDD 103.

The medical image table is used to manage correspondences between information about medical images and information about vein patterns. The medical image table also contains an image of a vein pattern (a vein pattern image) appearing in the same imaged area as a corresponding medical image, in association with the medical image. A medical image and vein pattern image having a correspondence reflect a relative positional relationship in the same imaged area between the subject (focus or another organ) of the medical image and the veins.

The vein pattern profile table contains the feature profile of a vein pattern. The video frame buffer is used to temporarily store image information obtained from the operative field imaging camera 22 and image information to be output to the monitor 11.

The registration unit 120 registers a medical image and information about a vein pattern, captured before surgery, in association with each other in the medical image table. The registration unit 120 creates a vein pattern profile table on the basis of a vein pattern image captured by the near-infrared camera 21, and stores the vein pattern profile table in the storage unit 110.

The display control unit 130 controls the image display of the monitor 11. The display control unit 130 includes a vein pattern search unit 131, an image transformation unit 132, and a composition unit 133.

The vein pattern search unit 131 compares information about a vein pattern obtained from the near-infrared camera 21 with the information about a plurality of vein patterns stored in the storage unit 110. By doing so, the vein pattern search unit 131 finds, from the information about the plurality of vein patterns stored in the storage unit 110, information about a vein pattern that matches the most with the information about the vein pattern obtained from the near-infrared camera 21.

The image transformation unit 132 obtains the medical image corresponding to the information about the vein pattern found by the vein pattern search unit 131 from the medical image table stored in the storage unit 110. The image transformation unit 132 compares the first image of the vein pattern found from the medical image table with the second image of the vein pattern obtained from the near-infrared camera 21 to obtain a size ratio of the second image to the first image. The image transformation unit 132 resizes the medical image according to the obtained size ratio.

In addition, the image transformation unit 132 determines where to place the resized medical image for superimposition on the image captured by the operative field imaging camera 22. The image transformation unit 132 uses the information about the vein pattern to make this determination.

As described earlier, a medical image and a vein pattern image registered in the medical image table reflect a relative positional relationship between the subject of the medical image and the veins. The image transformation unit 132 calculates a rotation angle, a magnification factor, and the direction and distance of parallel displacement for the medical image, based on how to make the vein pattern image in the medical image table overlap the vein pattern image of the imaged area captured by the near-infrared camera 21. For example, the image transformation unit 132 collectively performs image transformation including rotation, resize, parallel displacement, and others of the medical image through the affine transformation.

The composition unit 133 generates image information by superimposing the medical image transformed by the image transformation unit 132 onto the image captured by the operative field imaging camera and outputs the generated image information to the monitor 11, which then displays an image based on the received image information.

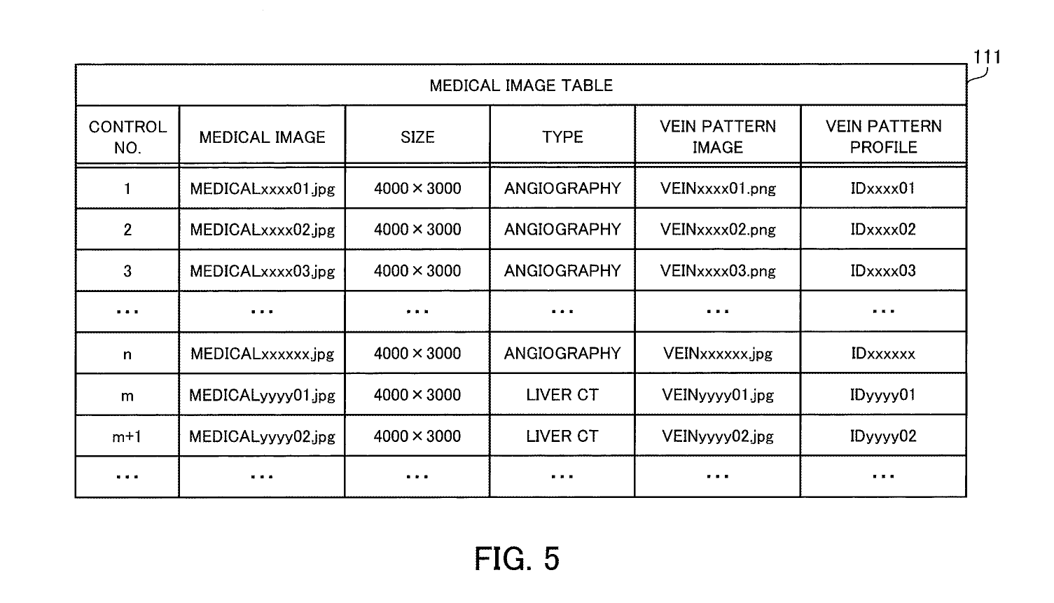

FIG. 5 illustrates an example of a medical image table. The medial image table 111 is stored in the storage unit 110. The medical image table 111 includes fields for control number (No.), medical image, size, type, vein pattern image, and vein pattern profile.

The control number field contains a number identifying a record. The medical image field contains a medical image. The size field indicates the size of the medical image. The type field contains type information indicating a means for capturing the medical image (CT, MRI, angiography, or another method). The type information may include the name of an imaged organ or others.

The vein pattern image field contains a vein pattern image captured together with the medical image. The vein pattern profile field contains information about a vein pattern profile representing the features of the vein pattern. In the medical image table 111, a plurality of medical images may be registered for one vein pattern image.

For example, the medical image table 111 has a record with in the control number field, “MEDICALxxxx01.jpg” in the medical image field, “4000×3000” in the size field, “ANGIOGRAPHY” in the type field, “VEINxxxx01.png” in the vein pattern image field, and “IDxxxx01” (ID stands for identifier) in the vein pattern profile field.

This record indicates the following. A medical image “MEDICALxxxx01.jpg”, a vein pattern image “VEINxxxx01.jpg”, and a vein pattern profile “IDxxxx01” are associated with each other. The medical image has a size of 4000×30000 pixels. The medical image is an image of blood vessels captured by the angiography. In addition, this record is identified by the control number of “1”.

The registration unit 120 previously obtains a medical image, a vein pattern image, and information about a vein pattern profile before surgery, and registers these in the medical image table 111. Means for capturing medical images include, for example, CT, MRI, Positron Emission Tomography (PET), angiography, Magnetic Resonance Angiography (MRA), non-contrast MRA, and others. The registration unit 120 previously obtains medical images of an organ, focus, or another to be treated, captured from all 360-degree directions, and registers the medical images in the medical image table 111. At this time, the registration unit 120 obtains a vein pattern image for each image capturing direction from the near-infrared camera 21, and registers the vein pattern image in association with the medical image captured from the same image capturing direction in the medical image table 111. The vein pattern profile is information representing the features of a vein pattern generated from the vein pattern image. The registration unit 120 is able to obtain a vein pattern image corresponding to a medical image by capturing an image of veins with the angiography or another method.

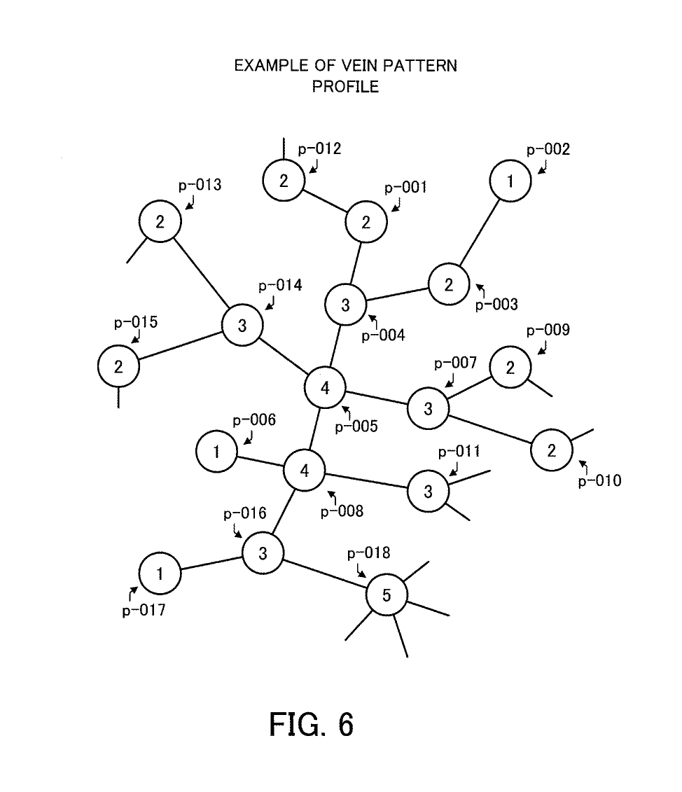

FIG. 6 illustrates an example of a vein pattern profile. In veins, blood vessels have a complicated branching structure. A branch point is connected to (i.e., linked to) another branch point with a blood vessel.

A vein pattern profile is information focusing on the branch points of blood vessels. The vein pattern profile indicates the number of branches (referred to as link count) at each branch point and the distance between branch points as the features of the vein pattern. Each branch point satisfies any one of the following conditions (1) to (3) with respect to the structure (simplified structure may be considered) of blood vessels represented in a vein pattern image.

(1) A point where there are three or more branches. (2) A point where a blood vessel is curved at a predetermined angle or less (for example, 160 degrees or less). (3) A point where a blood vessel ends.

With respect to a branch point satisfying the condition (1), the number of actual branches is taken as the link count. With respect to a branch point satisfying the condition (2), the link count is set to two. With respect to a branch point satisfying the condition (3), the link count is set to one.

The exemplary vein pattern profile of FIG. 6 includes branch points p-001, p-002, . . . , p-018. For example, the branch point p-001 satisfies the condition (2), and therefore its link count is two. The branch point p-002 satisfies the condition (3), and therefore its link count is one. The branch point p-018 satisfies the condition (1). Since there are five branches at the branch point p-018, its link count is five.

The image processing apparatus 100 manages such a vein pattern profile using a vein pattern profile table. The image processing apparatus 10 creates a vein pattern profile table for each vein pattern image.

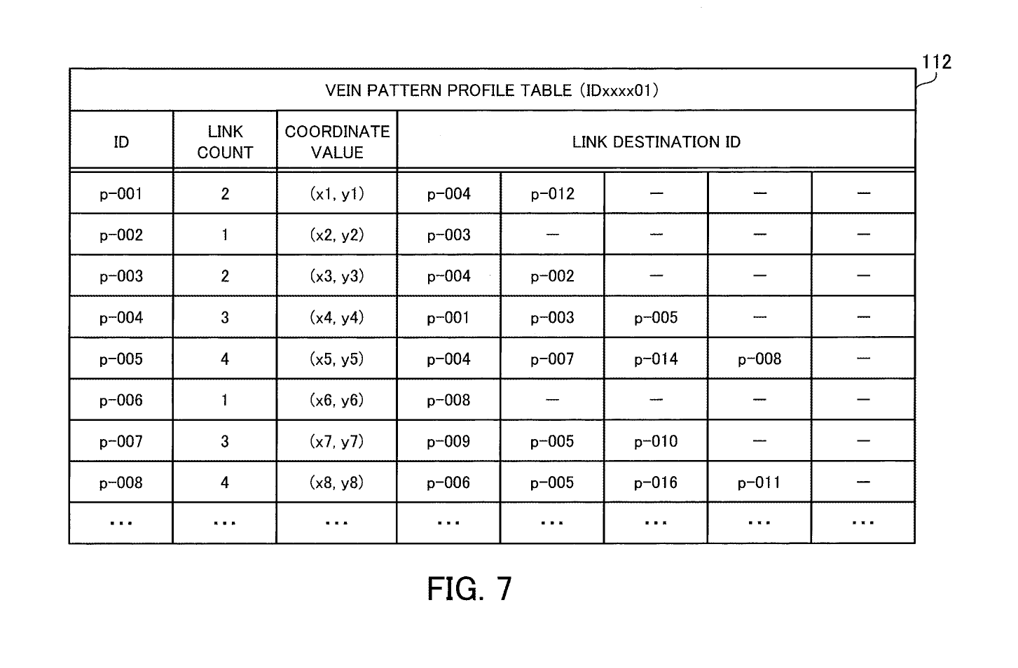

FIG. 7 illustrates an example of a vein pattern profile table. The vein pattern profile table 112 is stored in the storage unit 110. The vein pattern profile table 112 manages the vein pattern profile exemplified in FIG. 6. For example, the vein pattern profile table 112 corresponds to the vein pattern profile with an identifier “IDxxxx01.” The vein pattern profile table 112 includes fields for ID, link count, coordinate value, and link destination ID.

The ID field contains an identifier (ID) identifying a branch point. The link count field indicates the number of links. The coordinate value field contains the coordinate values of the branch point. The link destination ID field contains the ID of a branch point (a link-destination branch point) having a link to that branch point with a blood vessel. The link destination ID field may contain a plurality of IDs. If so, these IDs may be listed in ascending order of their distance to the branch point of attention. “A distance between branch points” is the length of a straight line connecting the branch points in the vein pattern image (two-dimensional image). If there is no link destination, “-” (hyphen) indicating no entry is contained in the link destination ID field.

For example, the vein pattern profile table 112 includes a record with “p-001” in the ID field, “2” in the link count field, “(x1, y1)” in the coordinate value field, “p-004, p-012” in the link destination ID field.

This record indicates the following. The branch point p-001 has two links and the coordinates of the branch point p-001 in the vein pattern image are (x1, y1). The branch point p-001 is adjacent to the branch points p-004 and p-012. For example, the distance between the branch points p-001 and p-004 is calculated as the distance between the coordinates (x1, y1) and (x4, y4). Since the link destination IDs are listed in the order of branch points p-004 and p-012, it is recognized that the distance between the branch points p-001 and p-004 is shorter than that between the branch points p-001 and p-012.

The registration unit 120 generates the same information as the vein pattern profile table 112 for each vein pattern image. The vein pattern search unit 131 determines with reference to the vein pattern profile tables 112 whether a vein pattern image obtained from the near-infrared camera 21 matches any of the registered vein patterns.

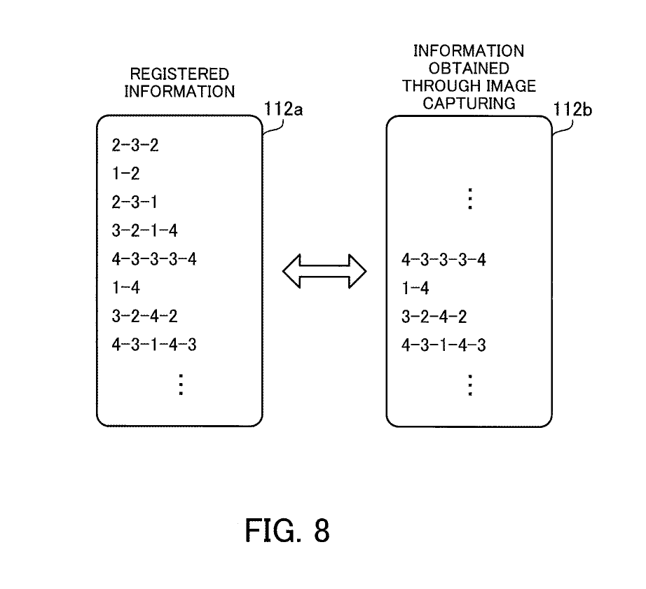

FIG. 8 illustrates how to compare vein pattern profiles. The vein pattern search unit 131 generates a quantized profile 112a on the basis of the vein pattern profile table 112. More specifically, the vein pattern search unit 131 generates a numerical sequence by arranging the link count of one branch point of attention and the link counts of the link-destination branch points of the branch point of attention in the same order as the link destination IDs listed in the vein pattern profile table 112. The vein pattern search unit 131 generates such numerical sequences for the individual branch points registered in the vein pattern profile table 112, and takes them as the quantized profile 112a.

In the case of the record with ID “p-001” in the vein pattern profile table 112, the branch point p-001 has two links, the branch point p-004, which is its link destination, has three links, and the branch point p-012, which is also its link destination, has two links (see FIG. 7). Therefore, the vein pattern search unit 131 generates a numerical sequence “2-3-2” for the record.

In addition, the vein pattern search unit 131 generates a quantized profile 112b on the basis of a vein pattern image captured by the near-infrared camera 21 in the same way as in the quantized profile 112a.

The vein pattern search unit 131 compares the quantized profile 112b with the plurality of quantized profiles corresponding to a plurality of vein pattern profile tables stored in the storage unit 110 to authenticate the vein pattern. To this end, the vein pattern search unit 131 determines a match, in view of up to the arrangement of the numerical values in numerical sequences. For example, a numerical sequence “1-2-3” and a numerical sequence “1-2-3” are considered to match. However, a numerical sequence “1-2-3” and a numerical sequence “1-3-2” are not considered to match.

The vein pattern search unit 131 searches the quantized profiles of the registered vein patterns to find a quantized profile which has the highest ratio (matching degree) of numerical sequences matching the quantized profile 112b obtained during surgery. For example, both of the quantized profiles 112a and 112b include numerical sequences “4-3-3-3-4,” “1-4,” “3-2-4-2,” and “4-3-1-4-3.” In this case, the vein pattern search unit 131 determines that the quantized profiles 112a and 112b match in terms of these numerical sequences.

For example, in the case where all of the numerical sequences included in the quantized profile 112b are included in the quantized profile 112a, the matching degree is 100%. In the case where half of all numerical sequences included in the quantized profile 112b are included in the quantized profile 112a, the matching degree is 50%.

The vein pattern search unit 131 generates a quantized profile for each of the plurality of vein pattern profile tables stored in the storage unit 110. The vein pattern search unit 131 searches the registered vein pattern profiles to find a vein pattern profile which matches the most (the highest matching degree) with the vein pattern profile obtained during surgery through the above comparison.

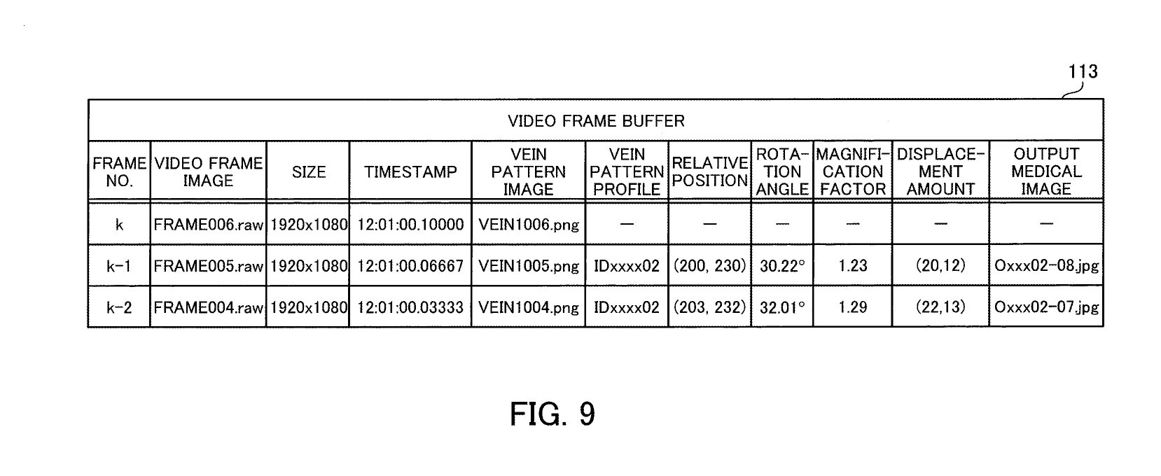

FIG. 9 illustrates an example of a video frame buffer. The video frame buffer 113 is stored in the storage unit 110. The video frame buffer 113 includes fields for frame number, video frame image, size, timestamp, vein pattern image, vein pattern profile, relative position, rotation angle, magnification factor, displacement amount, and output medical image.

The frame number field contains a frame number. The frame number is incremented one by one each time an image is obtained from the operative field imaging camera 22. The operative field imaging cameral 22 captures images of the operative field at a frame rate of 30 frames per second (fps), for example.

The video frame buffer 113 is able to store three images. When obtaining a new frame image, the image processing apparatus 100 deletes the oldest information from the video frame buffer 113 and adds the new frame image in the video frame buffer 113.

For example, the image with frame number k (k is an integer of three or greater) is the latest image obtained from the operative field imaging camera 22, and is not yet subjected to the image processing by the image processing apparatus 100. In this case, a storage area for storing the image with frame number k may be called a read buffer for reading a video frame image or a vein pattern image.

The image with frame number k-1 is an image captured one frame before the frame number k, and is already subjected to the image processing by the image processing apparatus 100. In this case, a storage area for storing the image with frame number k-1 may be called an image processing buffer.

The image with frame number k-2 is an image captured two frames before the frame number k, and is to be output from the image processing apparatus 100 to the monitor 11. In this case, a storage area for storing the image with frame number k-2 may be called an output buffer.

The video frame image field contains information about an operative field image generated by the operative field imaging camera 22. The size field indicates the size of the image. The timestamp field contains the timestamp indicating when the image was obtained. The vein pattern image field contains information about a vein pattern image generated by the near-infrared camera 21 together with the operative field image. The vein pattern profile field contains information about a vein pattern profile corresponding to the vein pattern image.

The relative position field indicates the coordinates (the coordinates of a corner closest to the origin) indicating the position of a rectangle where the vein pattern is detected in the vein pattern image. The rotation angle field contains information about a rotation angle for a medical image for its superimposition onto the operative field image. The magnification factor field contains information about a magnification factor for the medical image for its superimposition onto the operative field image. The displacement amount field contains information about a vector indicating the direction and amount of parallel displacement of the medical image for its superimposition onto the operative field image. The output medical image field contains a medical image subjected to the transformation (the above rotation, resize, and parallel displacement), to be superimposed onto the operative field image.

For example, the video frame buffer 113 includes a record with “k” in the frame number field, “FRAME006.raw” in the video frame image field, “1920×1080” in the size field, “12:01:00.10000” in the timestamp field, “VEIN1006.png” in the vein pattern image field, and no entry “-” in the vein pattern profile, relative position, rotation angle, magnification factor, displacement amount, and output medical image fields.

This record indicates the following. A video frame image “FRAME006.raw” corresponding to the fame number k is obtained. The video frame image has a size of “1920×1080” pixels and is an image obtained at 12:01:00.1. The vein pattern image “VEIN1006.png” is obtained together with the video frame image. In this connection, the image processing is not yet performed on the frame number k at the time when the content of the video frame buffer 113 illustrated in FIG. 9 is obtained. Therefore, no data (“-”) is entered in the vein pattern profile, relative position, rotation angle, magnification factor, displacement amount, and output medical image fields.

In addition, the video frame buffer 113 includes a record with “k-1” in the frame number field, “FRAME005.raw” in the video frame image field, “1920×1080” in the size field, “12:01:00.06667” in the timestamp field, “VEIN1005.png” in the vein pattern image field, “IDxxxx02” in the vein pattern profile field, “(200, 230)” in the relative position field, “30.22°” in the rotation angle field, “1.23” in the magnification factor field, “(20, 12)” in the displacement amount field, and “Oxxx02-08.jpg” in the output medical image field.

This record indicates the following. A video frame image “FRANE005.raw” corresponding to the fame number k-1 is obtained. The video frame image has a size of “1920×1080” pixels and is an image obtained at 12:01:00.06667. Further, the vein pattern image “VEIN1005.png” is obtained together with the video frame image. Still further, information about a vein pattern profile identified by “IDxxxx02” is obtained for the vein pattern image. The coordinates of a corner, closest to the origin, of a rectangle where the vein pattern is detected in the operative field image are “(200, 230).” The output medical image “Oxxx02-08.jpg” to be superimposed onto the video frame image “frame005.raw” is already generated. The output medical image is generated by performing the affine transformation on the original medical image using a rotation angle of 30.22 degrees, a magnification factor of 1.23, and a vector (20, 12) indicating parallel displacement.

The following describes a procedure in an image processing system according to the second embodiment. First, a procedure for registering a medical image in the storage unit 110 will be described. As described earlier, a medical image is obtained with the CT, MRI, or another before surgery.

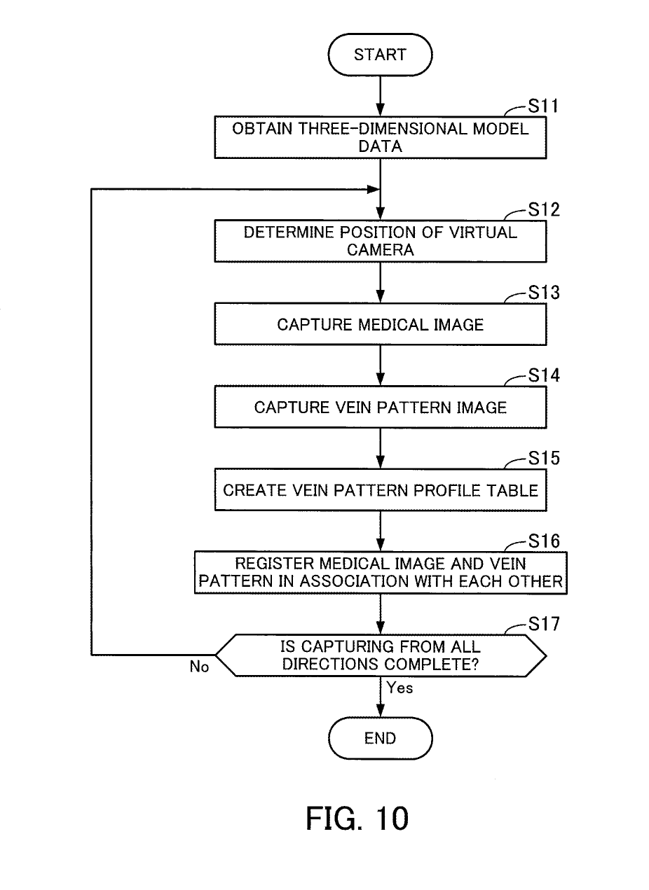

FIG. 10 is a flowchart illustrating an example of how to register a medical image. The process of FIG. 10 will be described step by step.

(S11) The registration unit 120 obtains the three-dimensional model data of an organ to be subjected to surgery. The image processing apparatus 100 may generate the three-dimensional model data from data obtained with the CT or another method, or may obtain the three-dimensional model data generated by another apparatus. The three-dimensional model data includes information about the surface and internal structure of the organ.

(S12) The registration unit 120 determines the position of a so-called virtual camera with respect to the three-dimensional model data. The virtual camera is one of the functions implemented by the registration unit 120 and is capable of capturing images of the three-dimensional model data from all directions. The virtual camera generates image information about the surfaces or cross-sections of one or a plurality of organs on the basis of the three-dimensional model data obtained, for example, with the CT or another method. When a doctor specifies an angle (image capturing direction) with respect to the three-dimensional model data, for example, the virtual camera generates image information about an image viewed from the specified angle.

(S13) The registration unit 120 captures a medical image. More specifically, the registration unit 120 uses the virtual camera function to capture a portion specified by an operator in the surface or internal structure of the organ represented by the three-dimensional model data, and generates the medical image.

(S14) The registration unit 120 captures a vein pattern image. More specifically, the registration unit 120 uses the near-infrared camera 21 to capture a vein pattern in the surface of the patient 50 from the same image capturing direction as in step S13. Alternatively, the registration unit 120 may use the virtual camera function to capture a vein pattern inside or outside the organ represented by the three-dimensional model data, obtained with the angiography or another method, from the same image capturing direction as in step S13. The registration unit 120 obtains the medical image and vein pattern image with respect to the same area of the patient 50 seen from a certain direction (for example, the same area within a prescribed error range). Therefore, the medical image and vein pattern image reflect a relative positional relationship between the subject (for example, focus or another organ) of the medical image and the vein pattern.

(S15) The registration unit 120 creates a vein pattern profile table on the basis of the vein pattern image captured at step S14. The registration unit 120 obtains the link count, coordinate values, and link destination IDs for each branch point with reference to the vein pattern image, and registers them in the vein pattern profile table.

(S16) The registration unit 120 registers the medical image and information about the vein pattern (the vein pattern image and the vein pattern profile table), obtained at steps S13 and S14, in association with each other in the medical image table 111.

(S17) The registration unit 120 determines whether capturing of medical images of the subject (for example, a focus, an organ, or another) from all directions is complete. If the image capturing from all directions is complete, the process is completed. If the image capturing needs to be done from one or more directions, the process proceeds back to step S12. In the following step S12, the registration unit 120 determines the position of the virtual camera so as to capture an image from a currently unselected direction.

As described above, the image processing apparatus 100 associates a medial image of a subject with information about a vein pattern. The image processing apparatus 100 obtains the medical image and the information about the vein pattern for each image capturing direction in association with each other. In addition, the image processing apparatus 100 creates a vein pattern profile table for each vein pattern image.

In this connection, it is considered that, in the case of capturing a vein pattern image with the near-infrared camera 21 at step S14, for example, the above steps S11 to S17 are executed while the patient 50 lies on an examination table after the data of the patient 50 as a whole is obtained with the CT or another method.

In the case of obtaining a vein pattern image with the virtual camera function at step S14, the above steps S11 to S17 may be executed at a desired time after the data of the patient 50 as a whole is obtained with the CT, angiography, or another method (this is because vein information is also obtained with the virtual camera function).

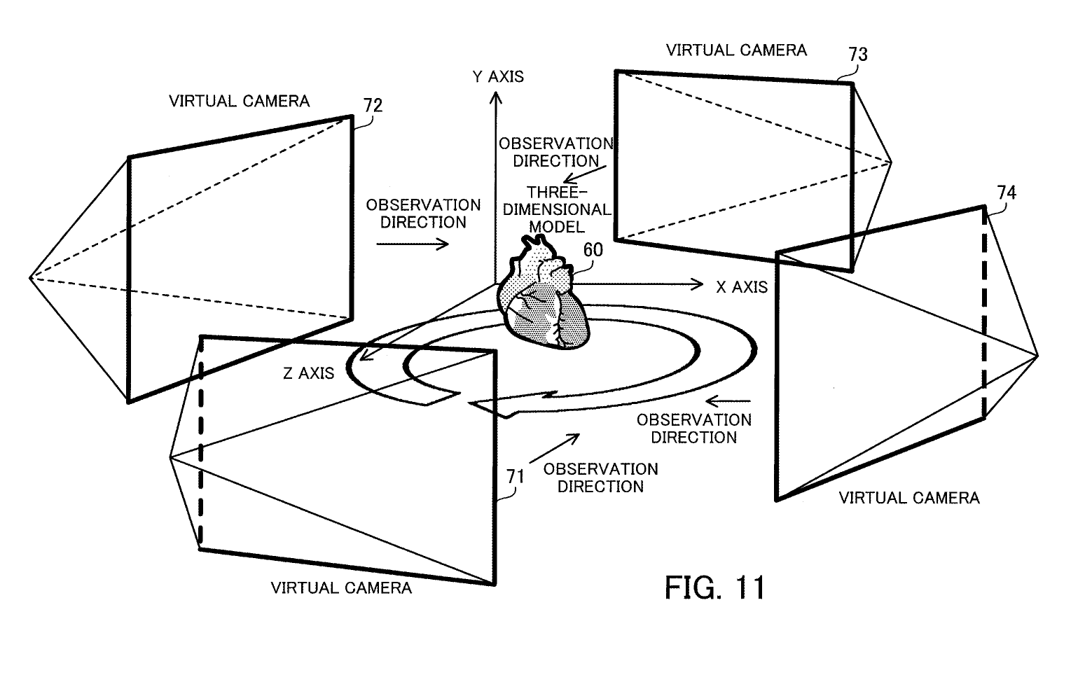

FIG. 11 illustrates an example of placement of a virtual camera with respect to a three-dimensional model. Three mutually orthogonal X-Y-Z axes are defined as follows. Referring to FIG. 11, the x axis is in the width direction of the patient 50 (the direction from the right to the left arm is taken as a positive direction). The Y axis is in the height direction of the patient 50 (the direction from the feet to the head is taken as a positive direction). The Z axis is in the front-back direction of the patient 50 (the direction from the back to the front is taken as a positive direction).

For example, the registration unit 120 obtains a three-dimensional model 60 representing the heart 51 of the patient 50 on the basis of data obtained with the CT or another method. The registration unit 120 determines the position of the virtual camera with respect to the three-dimensional model 60.

For example, the virtual camera 71 is positioned so as to capture the three-dimensional model at a prescribed position on the front side (the positive Z axis side). The image capturing direction (observation direction) of the virtual camera 71 for capturing the three-dimensional model 60 is from the positive Z axis to the negative Z axis.

The position of the virtual camera 72 is obtained by rotating the virtual camera 71 by 90 degrees clockwise, when the three-dimensional model 60 is viewed from the positive Y axis side, with respect to an axis passing through the center (may be the center of gravity) of the three-dimensional model 60 and being parallel to the Y axis. The observation direction of the virtual camera 72 is from the negative X axis to the positive X axis.

The position of the virtual camera 73 is obtained by rotating the virtual camera 72 by 90 degrees clockwise with respect to the axis passing through the center of the three-dimensional model 60 and being parallel to the Y axis. The observation direction of the virtual camera 73 is from the negative Z axis to the positive Z axis.

The position of the virtual camera 74 is obtained by rotating the virtual camera 73 by 90 degrees clockwise with respect to the axis passing through the center of the three-dimensional model 60 and being parallel to the Y axis. The observation direction of the virtual camera 74 is from the positive X axis to the negative X axis.

The above example describes the four positions for the virtual camera, separated by 90 degrees apart. Alternatively, the registration unit 120 obtains medial images while changing the position of the virtual camera, for example, 0.5 by 0.5 degree or 1 by 1 degree (greater degrees (5 by 5 degrees, 10 by 10 degrees) may be possible). In addition, the position of the virtual camera is determined by rotation with respect to the axis passing through the center of the three-dimensional model 60 and being parallel to the Y axis. Alternatively, it is also considered to make the rotation with respect to an axis passing through the center of the three-dimensional model 60 and being parallel to the X or Z axis. Medical images may be obtained by the virtual camera rotated by a combination of rotation angles about two or more axes. In addition, the above example rotates the virtual camera. Alternatively, medical images may be obtained while rotating the three-dimensional model 60, with the position of the virtual camera fixed.

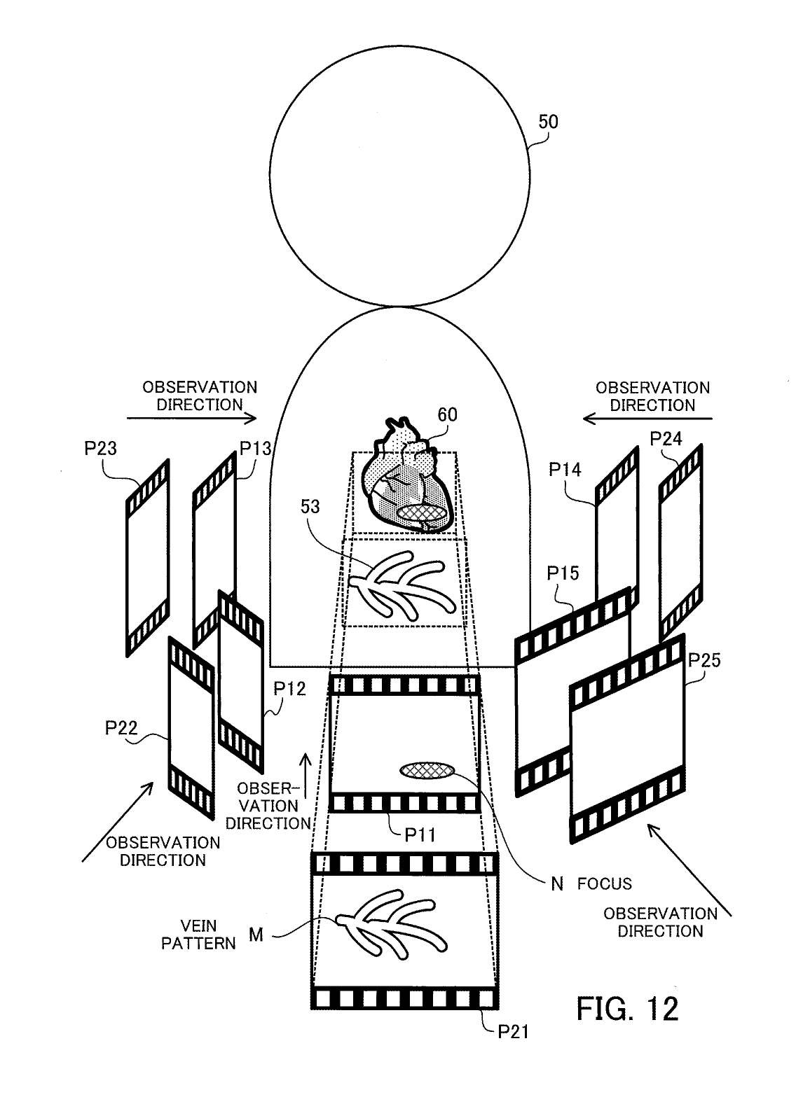

FIG. 12 illustrates a first example of capturing a vein pattern. For example, the registration unit 120 uses the near-infrared camera 21 to obtain a vein pattern image with respect to each of the observation directions from which the virtual camera captured medical images. For example, the registration unit 120 causes the virtual camera to capture the three-dimensional model 60 from an observation direction, to thereby obtain a medical image P11 including an image of a focus N on the surface of or inside the three-dimensional model 60. At this time, the registration unit 120 places the near-infrared camera 21 at the same position as the virtual camera and causes the near-infrared camera 21 to capture the near-infrared light reflected from the skin of the patient 50, to thereby obtain a vein pattern image P21.

For example, the near-infrared camera 21 is placed at the same position as the virtual camera 71 and is caused to capture a vein pattern of the patient 50. At this time, the distance between the near-infrared camera 21 and the heart 51 matches the distance between the virtual camera 71 and the three-dimensional model 60 (within a prescribed error range). In addition, the near-infrared camera 21 has the same observation direction as the virtual camera 71. Since the registration unit 120 is able to recognize the position of the heart 51 of the patient 50 from a result of the CT or the like, the registration unit 120 is able to determine the position of the near-infrared camera 21 with respect to the position of the heart 51 even before surgery.

Then, the registration unit 120 obtains the vein pattern image P21 including a vein pattern M corresponding to veins 53 appearing on the surface of the patient 50 from the near-infrared camera 21. In this case, the medical image P11 and the vein pattern image P21 reflect the relative positional relationship between the focus N and the vein pattern M of the patient 50 when viewed from a certain observation direction.

Similarly, the registration unit 120 obtains a combination of a medical image P12 including an image of the focus N and a vein pattern image P22 including the vein pattern M while changing the observation direction. FIG. 12 exemplifies, in addition to these combinations, a combination of a medical image P13 and a vein pattern image P23, a combination of a medical image P14 and a vein pattern image P24, and a combination of a medical image P15 and a vein pattern image P25.

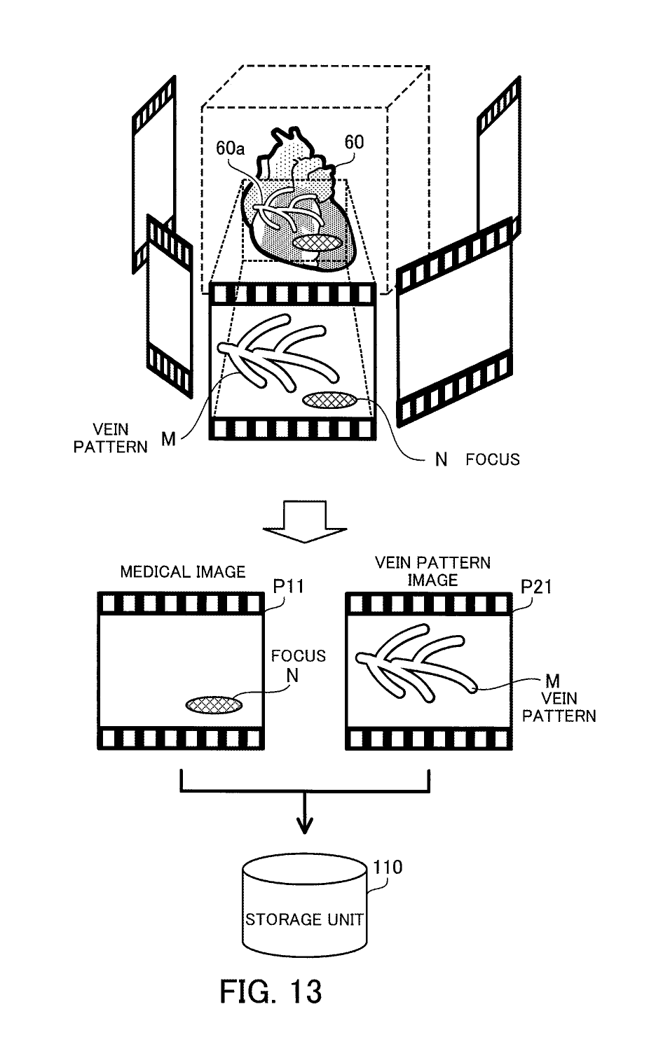

FIG. 13 illustrates a second example of capturing a vein pattern. As described earlier, it is considered that blood vessel data of the patient 50 is also obtained by the angiography or another method. In that case, the registration unit 120 may obtain a medical image P11 and a vein pattern image P21 with the virtual camera on the basis of the three-dimensional model data of the blood vessels.

More specifically, the registration unit 120 obtains a three-dimensional model 60a corresponding to the veins 53 with the angiography or another method, and reproduces the internal structure of the patient 50 using the three-dimensional models 60 and 60a. If the three-dimensional model 60a is within an area where the focus N is captured with the virtual camera from a certain observation direction, the registration unit 120 is able to obtain the vein pattern image P21 of the vein pattern M by capturing an image of the three-dimensional model 60a. In this case, the three-dimensional model 60a may correspond not to the veins 50 appearing on the surface of the patient 50 but to veins deep inside the patient 50 (for example, a three-dimensional model representing veins on the surface of or inside the heart 51 or another organ may be possible).

With the methods exemplified in FIGS. 12 and 13, the registration unit 120 obtains a combination of a medical image and a vein pattern image for each observation direction, and stores the medical image and the vein pattern image in association with each other in the storage unit 110. For example, the registration unit 120 stores the medical image P11 and the vein pattern image P21 in association with each other in the storage unit 110. In addition, the registration unit 120 creates a vein pattern profile table with reference to the vein pattern image P21, and stores the vein pattern profile table in association with the medical image in the storage unit 110. The registration unit 120 may obtain a vein pattern image of veins of a different portion according to an angle, and associate the vein pattern image with a medical image.

With the information registered as above, the image processing apparatus 100 assists the doctor 40 in surgery of the patient 50. The following describes how the image processing apparatus 100 performs image processing during surgery.

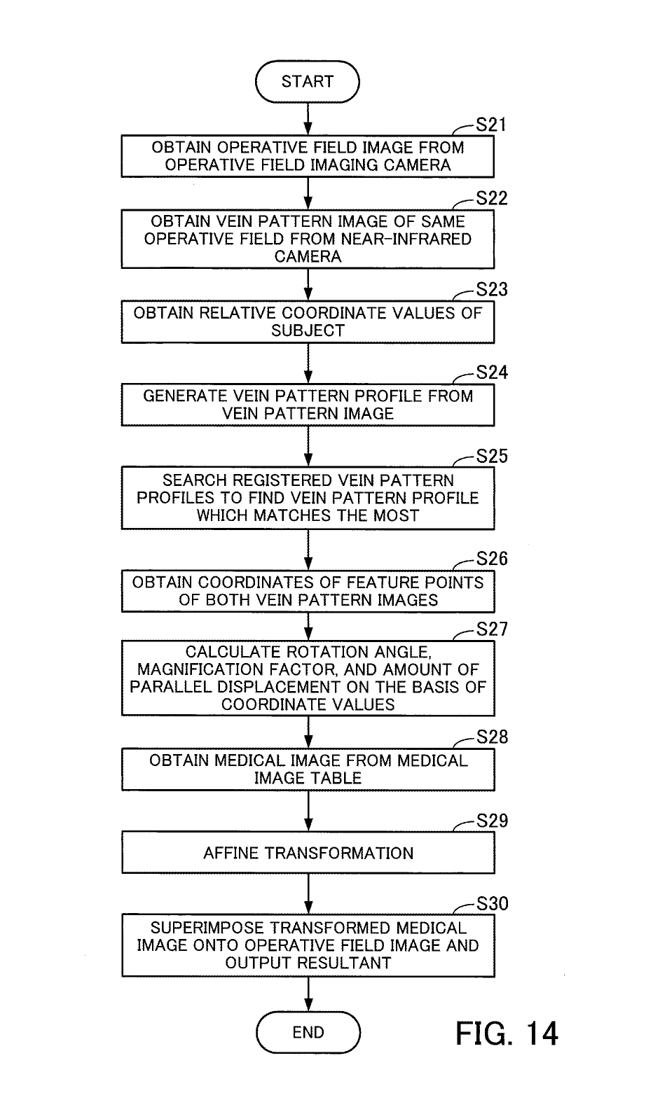

FIG. 14 is a flowchart illustrating an example of image processing. The process of FIG. 14 will be described step by step.

(S21) The vein pattern search unit 131 obtains an operative field image of the current frame (for example, frame number k) from the operative field imaging camera 22 and stores the operative field image in the video frame buffer 113.

(S22) The vein pattern search unit 131 obtains a vein pattern image of the same operative field (the same operative field as captured by the operative field imaging camera 22) as represented by the current frame (for example, frame number k) from the near-infrared camera 21, and stores the vein pattern image in the video frame buffer 113. After that, the image processing is performed on the operative field image of that frame (for example, frame number k) and the vein pattern image.

(S23) The vein pattern search unit 131 obtains the relative coordinate values of the subject with reference to the vein pattern image and enters the relative coordinate values in the relative position field of the video frame buffer 113. The relative coordinate values of the subject indicate the position of a rectangle where the vein pattern is detected, with respect to the origin of the vein pattern image, and are the coordinates of one corner closest to the origin out of the four corners of the rectangle.

(S24) The vein pattern search unit 131 generates a vein pattern profile (referred to as a captured profile) from the vein pattern image obtained at step S22.

(S25) The vein pattern search unit 131 searches the plurality of vein pattern profiles (referred to as registered profiles) registered in the medical image table 111 to find a vein pattern profile that matches the most with the captured profile generated at step S24. This search is done in the same way as exemplified in FIG. 8. More specifically, the vein pattern search unit 131 compares the plurality of quantized profiles obtained from the plurality of registered profiles with the quantized profile obtained from the captured profile. The vein pattern search unit 131 then specifies a quantized profile whose matching degree with the quantized profile obtained from the captured profile is greater than or equal to a specified threshold and is the greatest, from the plurality of quantized profiles corresponding to the plurality of registered vein pattern profiles. The specified threshold is registered in the storage unit 110 in advance, and is set to a value appropriate for the circumstances, for example, 80% to 95%. The vein pattern search unit 131 takes the registered profile corresponding to the specified quantized profile as the search result of step S25.

(S26) The image transformation unit 132 obtains the search result of step S25 from the vein pattern search unit 131. The image transformation unit 132 obtains the coordinates of a plurality of feature points from the captured profile. The image transformation unit 132 obtains the coordinates of the plurality of feature points from the registered profile found by the vein pattern search unit 131. The coordinates of a feature point are, for example, the coordinates of a branch point.

(S27) The image transformation unit 132 obtains a first bounding box on the basis of the coordinates of the plurality of feature points of the captured profile. The bounding box is the smallest rectangle that contains all of the coordinates of the plurality of feature points of attention. The image transformation unit 132 then obtains a second bounding box on the basis of the coordinates of the plurality of feature points of the registered profile found by the vein pattern search unit 131. The image transformation unit 132 calculates a rotation angle, magnification factor, and parallel displacement vector for the second bounding box, based on how to make the second bounding box overlap the first bounding box exactly. The image transformation unit 132 registers the calculated information in the video frame buffer 113.

(S28) The image transformation unit 132 obtains the medical image corresponding to the registered profile found by the vein pattern search unit 131 from the medical image table 111.

(S29) The image transformation unit 132 performs the affine transformation on the medical image obtained at step S28. More specifically, the image transformation unit 132 transforms the original coordinate values (x, y) of the medical image to the coordinate values (x′, y′) in the operative field image with the following equation (1).

$$( \begin{matrix}{x}^{′} \\ {y}^{′} \\ 1\end{matrix} ) = ( \begin{matrix}{α}_{11} & {α}_{12} & {α}_{13} \\ {α}_{21} & {α}_{22} & {α}_{23} \\ 0 & 0 & 1\end{matrix} ) ( \begin{matrix}x \\ y \\ 1\end{matrix} ) \qquad ( 1 )$$

The parameters α11, α12, α21, and α22 are components for rotation and magnification factor. The image transformation unit 132 determines the parameters α11, α12, α21, and α22 according to the rotation angle and magnification factor calculated at step S27. The parameters α13 and α23 are components for parallel displacement. The image transformation unit 132 determines the parameters α13 and α23 according to the parallel displacement vector calculated at step S27. The image transformation unit 132 registers the medical image subjected to the affine transformation as an output medical image in the video frame buffer 113.

(S30) The composition unit 133 obtains the operative field image (video frame image) and the medical image subjected to the affine transformation from the video frame buffer 113, and generates image information by superimposing the medical image subjected to the affine transformation onto the operative field image. The composition unit 133 outputs the generated image information to the monitor 11.

As described above, the image processing apparatus 100 superimposes a medical image onto an operative field image. The monitor 11 displays an image based on the image information obtained from the image processing apparatus 100. The doctor 40 is able to recognize the arrangement of a focus, other organs and blood vessels in the vicinity of the organ of attention, and others with reference to the image displayed on the monitor 11. The above explanation focuses on the frame number k, and the display control unit 130 executes the procedure of FIG. 14 for each frame.

In this connection, it is considered that the image transformation unit 132 executes steps S26 to S29 on the basis of the information about relative positions registered in the video frame buffer 113 in a simpler way. For example, when detecting that a vein pattern profile found for a previous frame is again found for the current frame, the image transformation unit 132 calculates a difference in the coordinate values registered in the relative position field of the video frame buffer 113 between the previous and current frames. The image transformation unit 132 then takes an image obtained by performing parallel displacement on the output medical image of the previous frame by the calculated difference as the output medical image of the current frame. After that, the same process as step S30 is performed.

By simplifying steps S26 to S29 executed by the image transformation unit 132 in the manner described as above, it is possible to alleviate the load on the image processing apparatus 100. In addition, it is possible to reduce a delay in displaying an output medical image.

In addition, in the above procedure, the image processing apparatus 100 uses a medical image corresponding to a captured vein pattern image to superimpose onto an operative field image captured at the same timing (same frame). However, it is possible to superimpose the medical image onto an operative image captured at different timing. This is because, in the case where the near-infrared camera 21, operative field imaging camera 22, and patient 50 are located at fixed positions, the operative field to be captured is considered to be at the almost same position even if there is a timing difference of one to several frames.

Further, it is considered to use a projector to project a medical image onto a body surface, which will be described later. In this case, step S21 may be omitted.

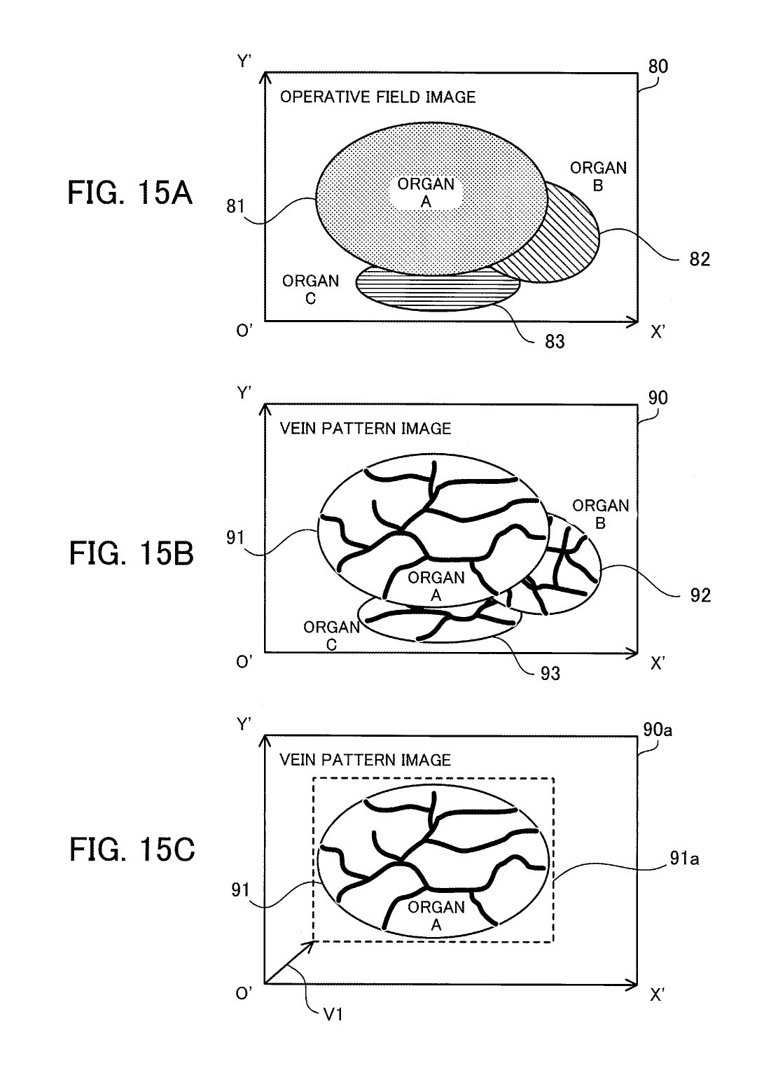

FIGS. 15A to 15C illustrate an example of captured images. FIG. 15A exemplifies an operative field image 80 captured by the operative field imaging camera 22. The operative field image 80 is rectangular. The lower left one of the four corners of the operative field image 80 is taken as the origin O′. In addition, the direction from the origin O′ to the right in this figure is taken as X′ axis, and the upward direction from the origin O′ as Y′ axis. The operative field image 80 includes an image 81 of an organ A, an image 82 of an organ B, and an image 83 of an organ C.

FIG. 15B exemplifies a vein pattern image 90 captured by the near-infrared camera 21. The vein pattern image 90 is obtained by capturing the same area as the operative field image 80 using near-infrared light. The coordinate system of the vein pattern image 90 is the same as that of the operative field image 80. The vein pattern image 90 includes a vein pattern image 91 of the organ A, a vein pattern image 92 of the organ B, and a vein pattern image 93 of the organ C.

FIG. 15C illustrates an area 91a where the vein pattern image 91 is detected in the vein pattern image 90. The vein pattern search unit 131 analyzes the vein pattern image 90 to detect the plurality of vein pattern images 91, 92, and 93 and then specify the largest rectangular area 91a, where the vein pattern image 91 is detected. The vein pattern search unit 131 takes the coordinates V1 of a corner (may be called a position vector V1 of the corner) of the area 91a, which is the closest to the origin, as the relative coordinate values of the subject.

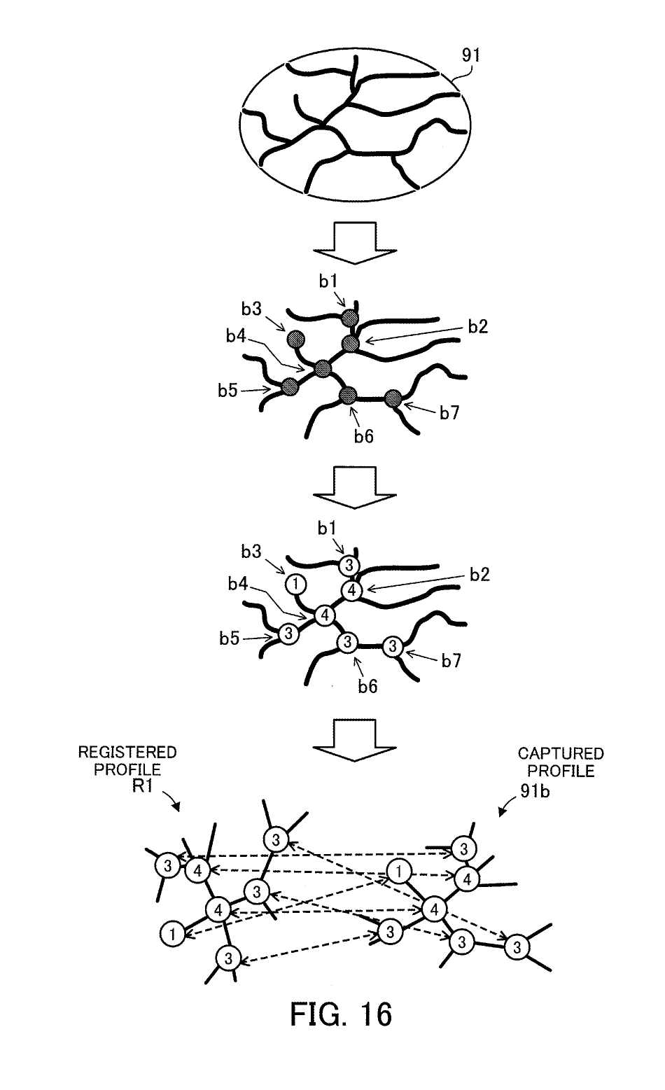

FIG. 16 illustrates an example of analyzing a vein pattern. The vein pattern search unit 131 detects the coordinate values of the branch points of veins in the vein pattern image 91. For example, the vein pattern search unit 131 detects branch points b1, b2, b3, b4, b5, b6, and b7 from the vein pattern image 91. Then, the vein pattern search unit 131 obtains the number of branches for each branch point. The branch points and the number of branches are obtained in the manner as exemplified in FIG. 6.

For example, as the number of branches, the branch point b1 has three branches, the branch point b2 has four branches, the branch point b3 has one branch, the branch point b4 has four branches, the branch point b5 has three branches, the branch point b6 has three branches, and the branch point b7 has three branches.

Then, the vein pattern search unit 131 generates information about the vein pattern profile (captured profile 91b) of the vein pattern image 91, and compares the information with the plurality of vein pattern profiles (registered profiles) previously registered in the storage unit 110. For example, the vein pattern search unit 131 finds a registered profile R1 that matches the most with the captured profile 91b (the matching degree is greater than or equal to a specified threshold and is the greatest).

In this connection, the vein pattern search unit 131 takes part or the whole of the vein pattern image 91 of the organ A as a subject to be analyzed. To analyze part of the vein pattern image 91, for example, the vein pattern search unit 131 is able to select a desired area including more than or equal to a prescribed number of feature points (branch points) from the vein pattern image 91.

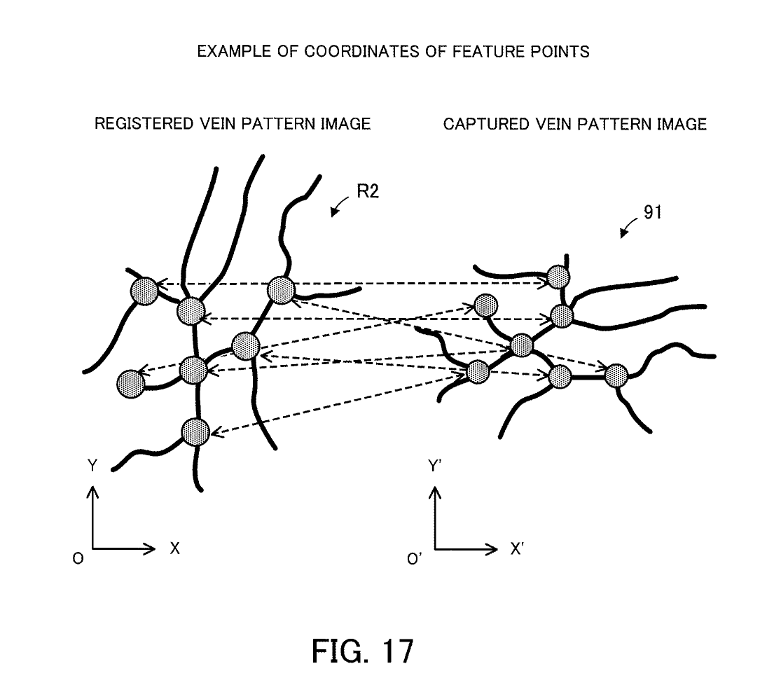

FIG. 17 illustrates an example of the coordinates of feature points. The image transformation unit 132 detects the coordinates of feature points in a vein pattern image R2 corresponding to the registered profile R1. The image transformation unit 132 detects the coordinates of feature points in the vein pattern image 91 corresponding to the captured profile 91b. The coordinates of branch points are considered as the coordinates of feature points, for example. Alternatively, another kind of feature points may be obtained. For example, branch points with more than or equal to a specified number of branches or the end points of veins may be considered as feature points.

In this connection, with regard to the coordinate axes, the X′-Y′ coordinates exemplified in FIGS. 15A to 15C may be considered for the vein pattern image 91. Similarly, with regard to the vein pattern image R2, out of the four corners of the rectangular image area, a corner corresponding to the origin O′ of the vein pattern image 91 is taken as the origin O. Then, the same direction as the X′ axis is taken as the X axis, and the same direction as the Y′ axis is taken as the Y axis. In this connection, an image area of a medical image is rectangular as well and the coordinate axes for the rectangular image area are considered with one of their four corners taken as the origin in the same manner as the vein pattern image R2.

The image areas of vein pattern images and medical images may not be rectangular, and their orthogonal coordinate axes and origin to be referenced may also be desirably set. However, the origin and coordinate axes in the registered vein pattern images and medical images are set in the same manner.

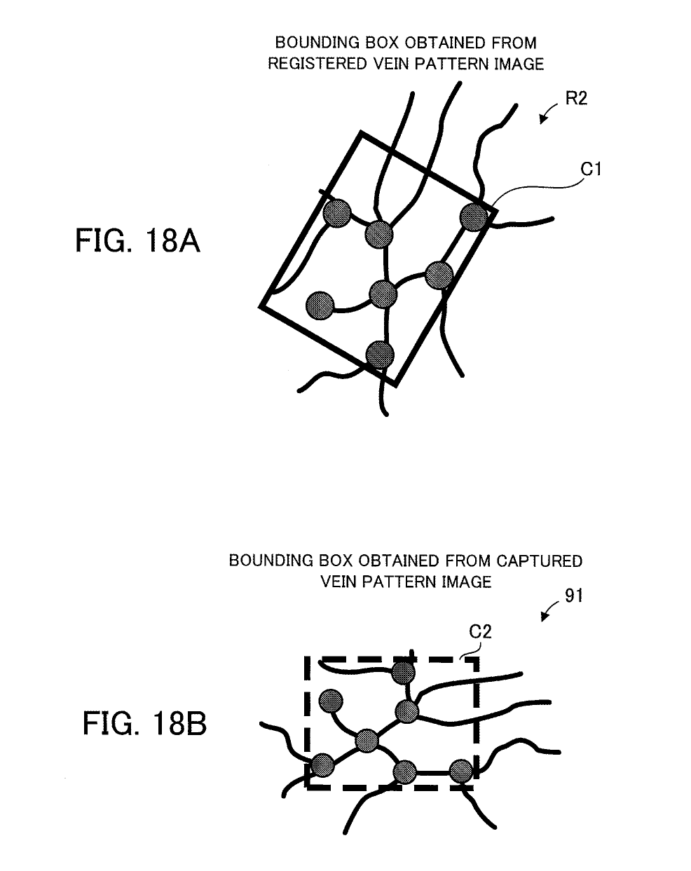

FIGS. 18A and 18B illustrate examples of a bounding box. The image transformation unit 132 detects a bounding box C1 containing the coordinates of a plurality of feature points detected from the vein pattern image R2 on the basis of the coordinates of the plurality of feature points. FIG. 18A exemplifies the bounding box C1.

The image transformation unit 132 detects a bounding box C2 containing the coordinates of a plurality of feature points detected from the vein pattern image 91 on the basis of the coordinates of the plurality of feature points. FIG. 18B exemplifies the bounding box C2.

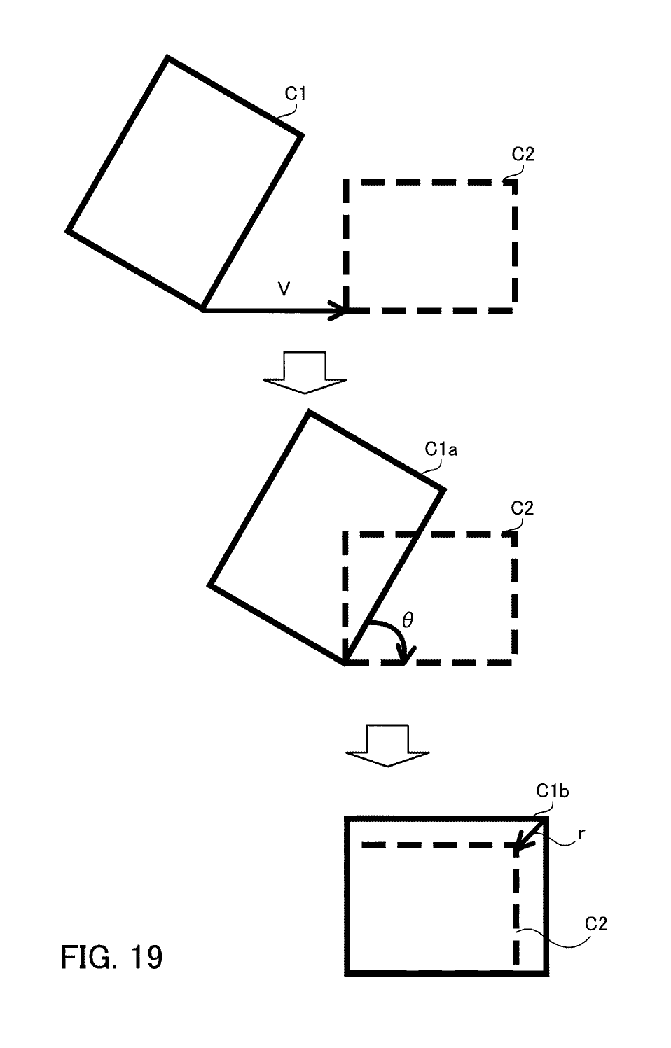

FIG. 19 illustrates an example of obtaining parameters for image transformation. The image transformation unit 132 calculates a parallel displacement vector V of the bounding box C1 such that one corner of the bounding box C1 and one corner of the bounding box C2 overlap each other when the origin of the vein pattern image R2 is mapped onto the origin of the vein pattern image 91. The bounding box C1 is moved with the parallel displacement vector V to thereby obtain a bounding box C1a.

The one corner of the bounding box C1a and the one corner of the bounding box C2 overlap each other. The image transformation unit 132 calculates a rotation angle θ of the bounding box C1a with respect to the overlapping corners. The rotation angle θ indicates how much to rotate the bounding box C1a with respect to the overlapping corners such that at least two sides of the bounding box C1a overlap two sides of the bounding box C2. The bounding box C1a is rotated by the rotation angle θ to thereby obtain a bounding box C1b.

The image transformation unit 132 calculates a magnification factor r such that the bounding box C1b overlaps the bounding box C2 exactly. The image transformation unit 132 obtains the magnification factor r from a ratio of the sides of the bounding boxes C1b and C2.

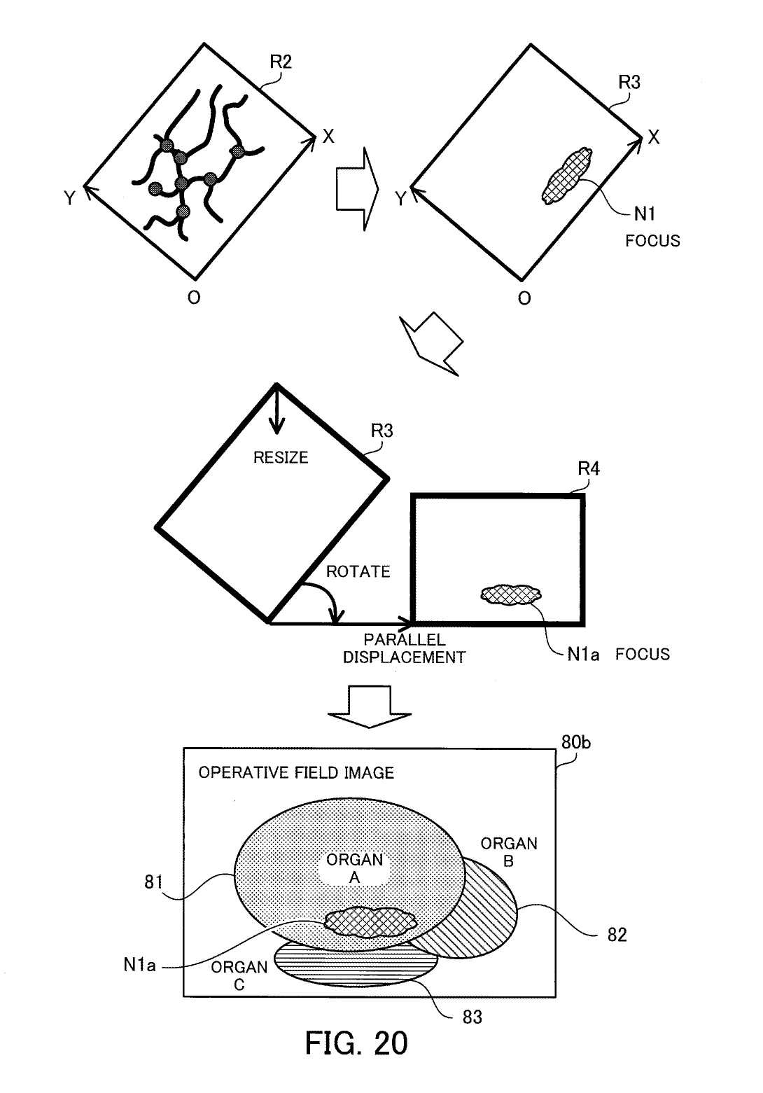

FIG. 20 illustrates an example of image transformation of a medical image. The image transformation unit 132 obtains a medical image R3 corresponding to the vein pattern image R2 from the medical image table 111. In FIG. 20, the rectangular image areas are inclined so that it is easy to understand that the vein pattern image R2 and medical image R3 are inclined with respect to the vein pattern image 91. In addition, the X-Y coordinates and the origin O are also exemplified in the vein pattern image R2 and medical image R3.

The medical image R3 includes an image of a focus N1, for example. The image transformation unit 132 performs the affine transformation on the medical image R3 with the magnification factor r, rotation angle θ, and parallel displacement vector V calculated in FIG. 19, thereby generating an output medical image R4. The output medical image R4 includes an image of a focus N1a corresponding to the image of the focus N1.

The composition unit 133 generates image information about an operative field image 80b by superimposing the output medical image R4 onto the operative field image 80, and outputs the image information to the monitor 11. The operative image 80b is obtained by superimposing the image of the focus N1a included in the output medical image R4 onto the image 81 of the organ A included in the operative field image 80. The monitor 11 displays the operative field image 80b. The doctor 40 is able to recognize the position of the focus N1a by viewing the operative field image 80b.

In this connection, the medical image R3 may include images of a plurality of focuses and organs. In that case, the image processing apparatus 100 may receive specification of a focus or organ to be output (for example, an input made by a user on the input device 12) and output only the specified focus, organ, or another. In this way, the image processing apparatus 100 is able to output part or the whole of the medical image R3, that is, to superimpose and display part or the whole of the medical image R3 on the operative field image 80.

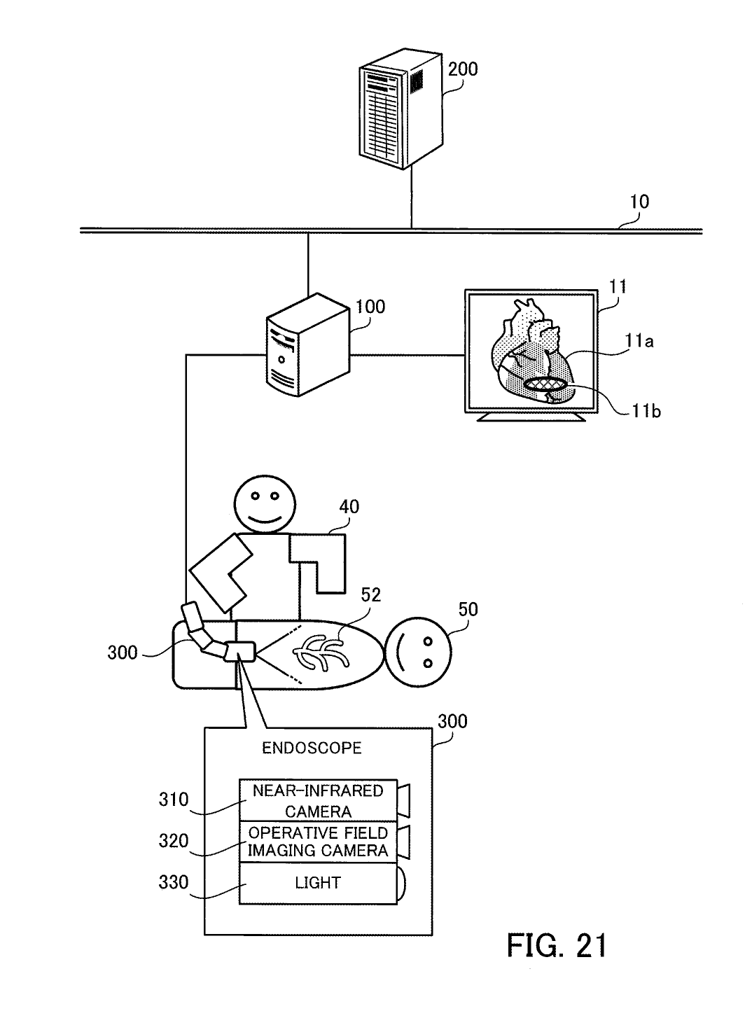

FIG. 21 illustrates a first example of another image processing system. The doctor 40 may perform laparoscopic surgery. In the laparoscopic surgery, an endoscope 300 may be used. In this case, it is considered that the endoscope 300 is equipped with a variety of cameras. More specifically, the endoscope 300 is equipped with a near-infrared camera 310, an operative field imaging camera 320, and a light 330. The near-infrared camera 310 corresponds to the near-infrared camera 21. The operative field imaging cameral 320 corresponds to the operative field imaging camera 22. The light 330 corresponds to the light 30.

An image processing apparatus 100 outputs image information generated by superimposing a medical image onto an operative field image on the basis of a vein pattern image of veins 52 captured by the endoscope 300, to a monitor 11. The monitor 11 then displays an image 11a including a medical image 11b of a focus.

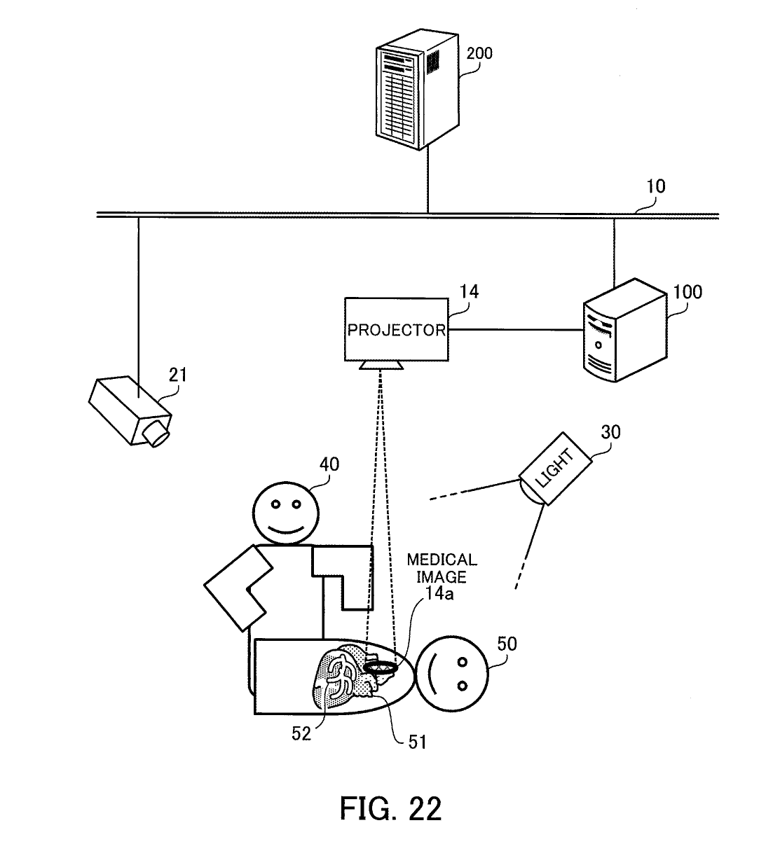

FIG. 22 illustrates a second example of another image processing system. For example, a projector 14 may be provided, instead of the monitor 11. The projector 14 projects a medical image 14a onto an operative field (for example, the skin or organ of a patient 50). In this case, the operative field imaging camera 22 may not be provided.

An image processing apparatus 100 outputs information about an output medical image to the projector 14 on the basis of a vein pattern image of veins 52 captured by a near-infrared camera 21. The projector 14 is previously positioned so as to project an image to the same imaged area as captured by the above-described operative field imaging camera 22. The projector 14 projects the medical image 14a onto an operative field on the basis of the information about the output medical image obtained from the image processing apparatus 100.

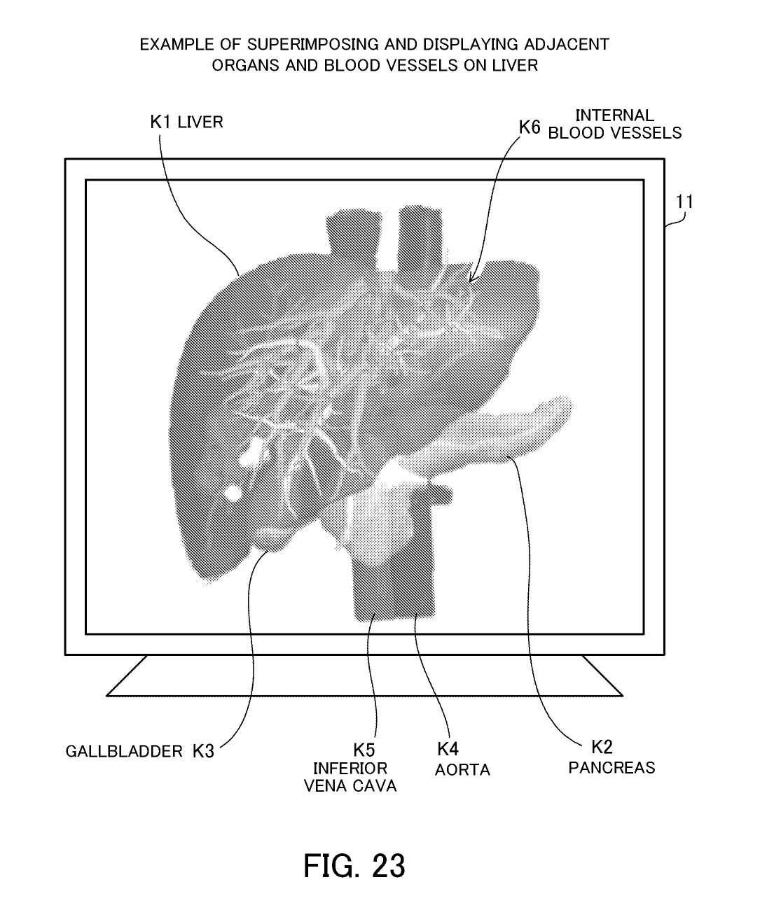

FIG. 23 illustrates a first example of display. FIG. 23 exemplifies the case of superimposing and displaying adjacent organs and blood vessels of a liver K1 on the liver K1, on the monitor 11. Referring to the example of FIG. 23, the monitor 11 displays the pancreas K2 and gallbladder K3 as the adjacent organs, and the aorta K4, inferior vena cava K5, and the internal blood vessels K6 of the liver K1 as the blood vessels.

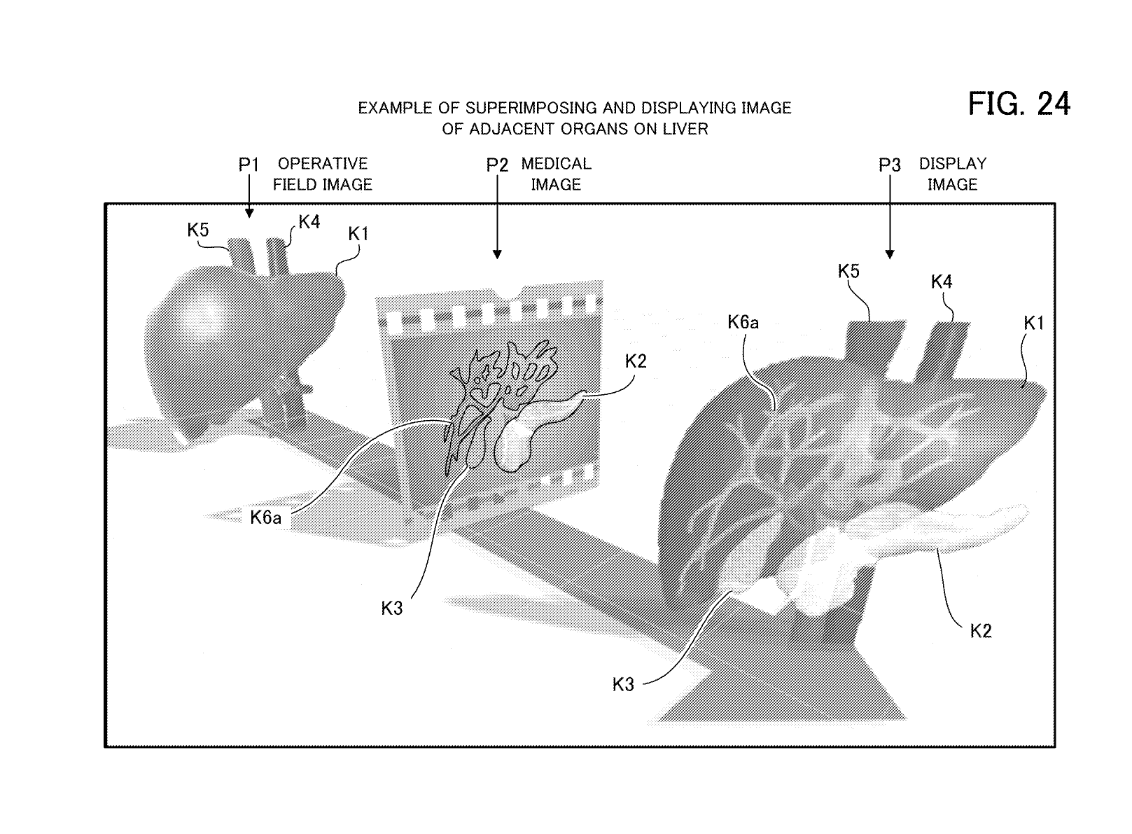

FIG. 24 illustrates a second example of display. FIG. 24 exemplifies the case of superimposing and displaying an image of adjacent organs on the liver K1. For example, the image processing apparatus 100 obtains an operative field image P1 from the operative field imaging camera 22. The operative field image P1 is captured using visible light. The operative field image P1 includes the liver K1, aorta K4, and inferior vena cava K5, but does not include images of the other organs and blood vessels behind or inside the liver K1. Therefore, it is not possible to recognize the arrangement of the other organs and blood vessels from the operative field image P1.

The image processing apparatus 100 obtains a medical image P2 from the medial image table 111 on the basis of a vein pattern image obtained from the near-infrared camera 21. The medical image P2 includes images of the pancreas K2 and gallbladder K3 in the vicinity of the liver K1. The medical image P2 also includes an image of the internal blood vessels K6a of the liver K1.

The image processing apparatus 100 generates image information about a display image P3 by superimposing the medical image P2 onto the operative field image P1. The image processing apparatus 100 may apply a visual effect to the display image P3 so that the liver K1 is transparent and the backside and inside thereof are visible. This provides a visual representation of the pancreas K2, gallbladder K3, and internal blood vessels K6a, which are actually hidden by the liver K1.

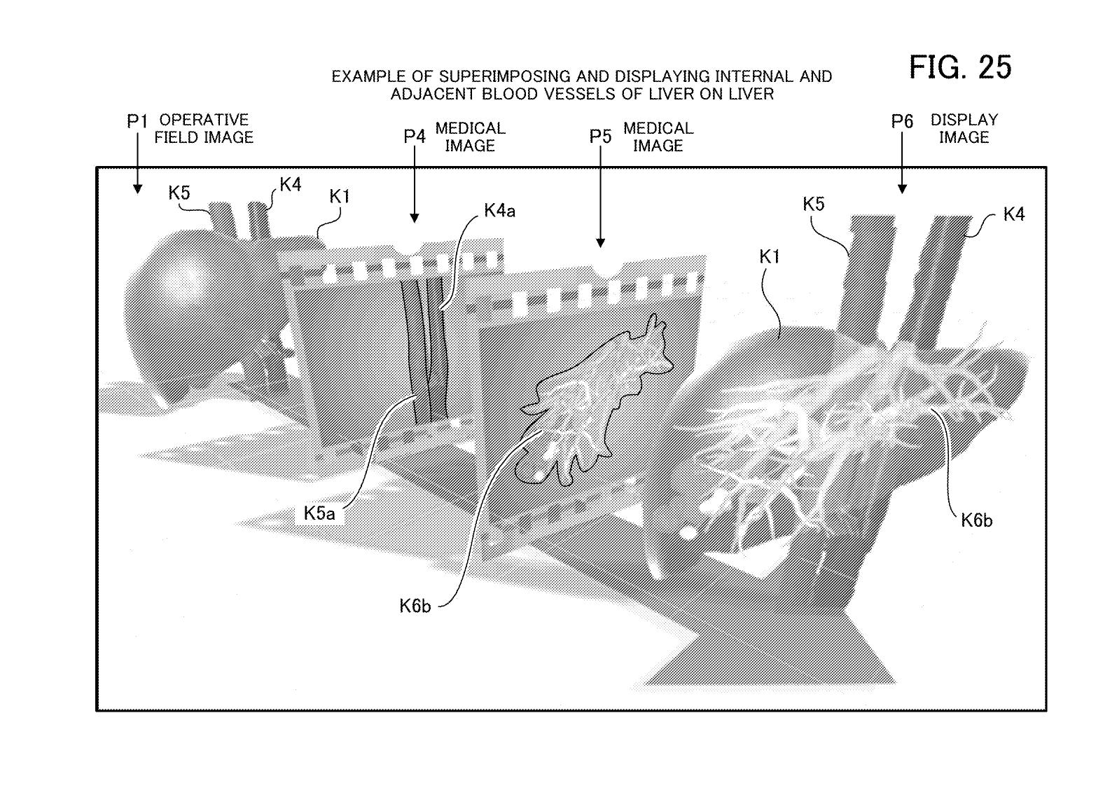

FIG. 25 illustrates a third example of display. FIG. 25 exemplifies the case of superimposing and displaying the internal and adjacent blood vessels of the liver K1 on an image of the liver K1. For example, the image processing apparatus 100 obtains an operative field image P1 from the operative field imaging camera 22.

The image processing apparatus 100 obtains medical images P4 and P5 from the medical image table 111 on the basis of a vein pattern image obtained from the near-infrared camera 21. In this connection, as described earlier, the medical image table 111 may contain a plurality of medical images in association with a single vein pattern image. The medical image P4 includes images of the aorta K4a and inferior vena cava K5a behind the liver K1. The medical image P5 includes an image of the internal blood vessels K6b (artery and veins) of the liver K1.

The image processing apparatus 100 complements an image of part of the aorta K4 and inferior vena cava K5 hidden behind the liver K1 with the images of the aorta K4a and inferior vena cava K5a. The image processing apparatus 100 may apply a visual effect to a display image P6 so that the liver K1 is transparent and the images of the aorta K4a, inferior vena cava K5a, and internal blood vessels K6b, which are actually hidden by the liver K1, are visible.

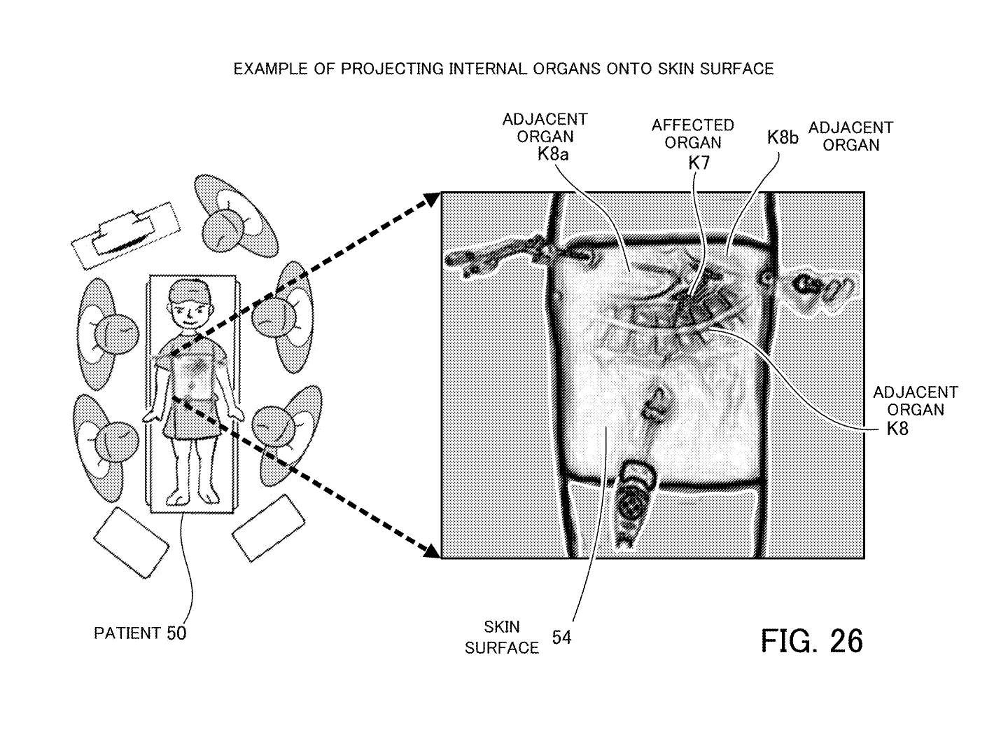

FIG. 26 illustrates a fourth example of display. FIG. 26 exemplifies the case where the projector 14 projects an image of organs under the skin onto a skin surface 54. For example, in the example of FIG. 26, adjacent organs K8, K8a, and K8b, as well as the affected organ K7, are projected onto the skin surface 54.

In this case, the image processing apparatus 100 is able to emit near-infrared light to the skin surface 54 to obtain a vein pattern image of veins on the skin surface and to compare the image with registered vein patterns.

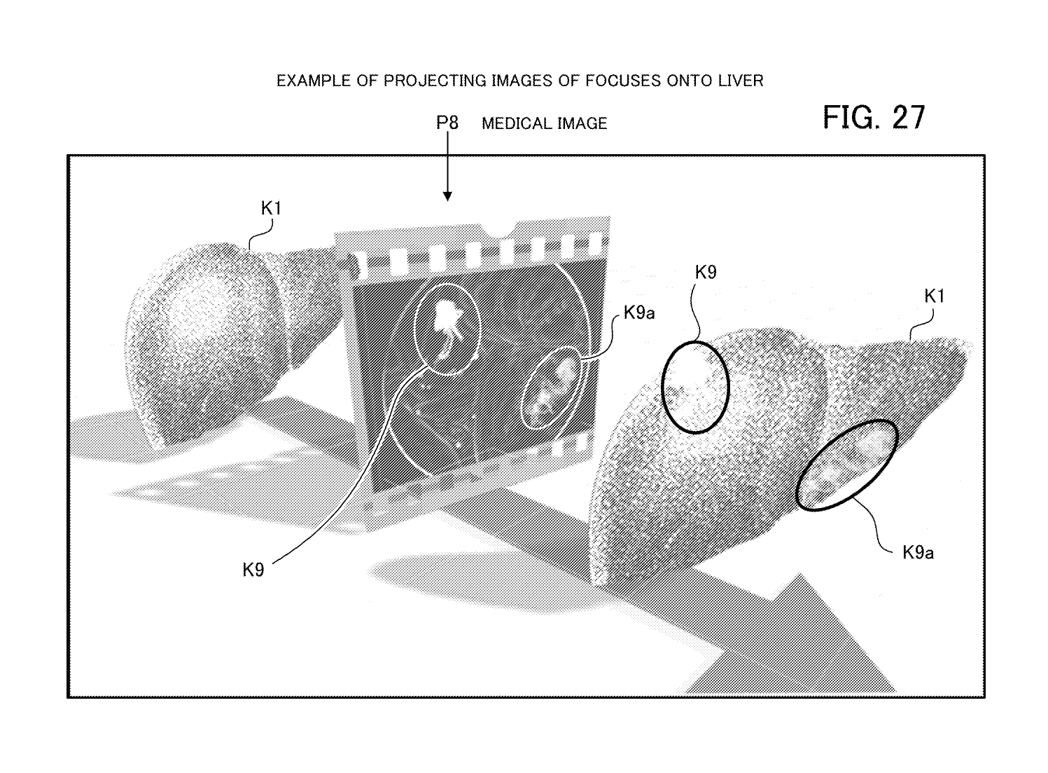

FIG. 27 illustrates a fifth example of display. FIG. 27 exemplifies the case where the projector 14 projects a medical image representing focuses inside the liver K1 onto the surface of the liver K1.

The image processing apparatus 100 obtains a medical image P8 from the medical image table 111 on the basis of a vein pattern image (for example, a vein pattern image of veins on the surface of or inside the liver K1 and veins in the vicinity of the liver K1) obtained from the near-infrared camera 21. The medical image P8 includes images of focuses K9 and K9a inside the liver K1. The image processing apparatus 100 colors the images of the focuses K9 and K9a to make them easily distinguishable from the surface of the liver K1, thereby generating an output medical image.

The image processing apparatus 100 outputs the output medical image to the projector 14, which then projects the medical image representing the focuses K9 and K9a onto the surface of the liver K1.

The image processing apparatus 100 of the second embodiment is able to superimpose and display a medical image on a biometric image. By the way, it is considered that an identification code, represented by a character string, and a medical image of a patient are stored in association with each other in the storage unit 110. In this case, however, entering a different identification code to the image processing apparatus 100 by mistake leads to outputting medical images of a different patient or a different organ. In addition, if identification codes are not properly managed for each patient or each organ, medical images of a different patient or a different organ may be output. Such an erroneous output of medical images may cause medical malpractice.

To deal with these, the image processing apparatus 100 outputs a medical image corresponding to a body part that is authenticated through biometrics authentication using a vein pattern image. A vein pattern is information unique to a living body. Therefore, a living body is properly identified using vein patterns, rather than using other kinds of information such as identification codes. In addition, since new information such as identification codes is not created by human work, mistakes are not likely to occur. Therefore, the above-described image processing apparatus 100 is able to output proper medical images for a patient's organ that is to be subjected to surgery, for example. Especially, the image processing apparatus 100 is able to easily obtain a vein pattern image with the near-infrared camera 21, without imposing the burden on the patient, together with a medical image. The vein pattern image and the medical image, which are obtained by observing a patient from the same observation direction, are easily associated with each other and are registered in advance.

A vein pattern image and a medical image previously registered in combination are obtained by observing a patient from the same observation direction. Therefore, the use of vein patterns for comparison makes it possible to output a proper medical image, which is captured from the observation direction from which an operative field is observed during surgery.

Further, the image processing apparatus 100 uses a vein pattern image to perform alignment for superimposing medical information onto image information. For example, a method is considered which places a reference point (a mark) on an operative field for measuring a position for the alignment. This method, however, needs some labor to mark the operative field. By contrast, the use of the vein pattern image for the alignment eliminates the need of the previous marking on the operative field.

In addition, since a great number of medical images may be managed, it is not realistic that a user places a mark on each medical image. The image processing apparatus 100 uses a vein pattern for the alignment, which eliminates the need of user's marking on each medical image. This alleviates the burden on patients and reduces the doctors' work.

In addition, the use of vein patterns achieves the alignment with high accuracy, rather than using man-made marks. As a result, it is possible to provide more appropriate assistance in surgery.

In the case of abdominal surgery, it is considered that a mark is written with a pen on the skin around a site to be cut, or is sealed thereon. However, in general, in the case of the abdominal surgery, only a site to be cut is exposed, and a surgical drape, surgical tools, such as forceps, and the wrists of a surgeon often shut out the skin around the site to be cut. Therefore, it is not easy to continuously display an image of the mark on the skin.

By contrast, the image processing apparatus 100 is able to output a medical image on the basis of the vein pattern of an operative field, so that there is a low possibility of shutting out the medical image by surgical tools or the wrists of a surgeon. Therefore, it is possible to continuously display the medical image with relatively high positioning accuracy.

In the case of laparoscopic surgery (endoscopic surgery), it is difficult to previously mark organs inside a body. In addition, since surgery is performed while capturing an image of part of an organ, it is rare to display an image of the entire organ and it is difficult to extract the shape of a displayed organ and place a mark thereon.

By contrast, the image processing apparatus 100 is able to output a medical image on the basis of a vein pattern in part of an organ or a vein pattern on a body surface. Therefore, even in the case of the laparoscopic surgery, it is possible to easily superimpose and display the medical image on an operative field image.

The information processing of the first embodiment may be implemented by causing a processor functioning as the display control unit 1b to run a program. In addition, the information processing of the second embodiment may be implemented by causing the processor 101 to run a program. Such a program may be recorded in the computer-readable recording medium 13.

For example, to distribute the program, the recording media 13 on which the program is recorded may be put on sale. Alternatively, the program may be stored in another computer and may be distributed over a network. A computer may store (install) the program recorded in the recording medium 13 or the program received from the other computer in a storage device, such as the RAM 102 or HDD 103, and may read and run the program from the storage device.

According to one aspect, it is possible to output medical information corresponding to a specific body part of a specific living body. In addition, according to one aspect, it is possible to superimpose and display medical information on a biometric image.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An output control method comprising:
acquiring a captured biometric image; and
outputting, by a computer, upon detecting that the acquired biometric image corresponds to biometric information of a specific body part of a specific living body, medical information registered in association with the specific body part of the specific living body.

2. The output control method according to claim 1, wherein the outputting includes displaying the medical information in association with the captured biometric image or a separately captured biometric image.

3. The output control method according to claim 1, wherein the biometric information is information about a vein pattern of the living body.

4. The output control method according to claim 3, wherein the outputting includes determining, based on the information about the vein pattern, a position for superimposing the medical information onto the captured biometric image or a separately captured biometric image.

5. The output control method according to claim 4, wherein the outputting includes generating an image for displaying the medical information based on information about a captured first vein pattern and information about a second vein pattern registered in association with the medical information.

6. The output control method according to claim 5, wherein the outputting includes determining a parameter for image transformation based on the information about the first and second vein patterns, and generating the image for displaying the medical information by transforming an image represented by the medical information using the parameter.

7. The output control method according to claim 1, wherein the medical information is information about an image of a focus, blood vessels, or an organ of the living body.

8. An image processing apparatus comprising:
a memory that stores a first biometric image of a living body obtained with a first imaging method in association with biometric information of the living body obtained with a second imaging method; and
a processor that performs a process including:
displaying, upon determining that biometric information of a certain living body obtained with the second imaging method corresponds to the biometric information stored in the memory, an image in which part or a whole of the first biometric image is superimposed on a second biometric image of the certain living body obtained with a third imaging method.

9. An image processing apparatus comprising:
a memory that stores a first biometric image of part of a living body obtained with a first imaging method in association with biometric information of the part of the living body obtained with a second imaging method; and
a processor that performs a process including:
displaying, upon determining that biometric information of part of a certain living body obtained with the second imaging method corresponds to the biometric information stored in the memory, an image in which part or a whole of the first biometric image is superimposed on a second biometric image of the part of the certain living body obtained with a third imaging method.

10. The image processing apparatus according to claim 8, wherein each of the biometric information stored in the memory and the biometric information of the certain living body is information about a vein pattern.

11. The image processing apparatus according to claim 10, wherein the process further includes determining, based on the information about the vein pattern, a position for superimposing the first biometric image onto the second biometric image.

12. The image processing apparatus according to claim 11, wherein the process further includes generating an image for displaying the first biometric image, based on information about a first vein pattern obtained with the second imaging method and information about a second vein pattern registered in association with the first biometric image.

13. The image processing apparatus according to claim 12, wherein the process further includes determining a parameter for image transformation based on the information about the first and second vein patterns, and generating the image for displaying the first biometric image by transforming the first biometric image using the parameter.

14. The image processing apparatus according to claim 8, wherein the first biometric image is an image of a focus, blood vessels, or an organ of the living body.

15. A non-transitory computer-readable storage medium containing an output control program that causes a computer to perform a process comprising:
acquiring a captured biometric image; and
outputting, upon detecting that the acquired biometric image corresponds to biometric information of a specific body part of a specific living body, medical information registered in association with the specific body part of the specific living body.

16. An information processing apparatus comprising a processor that performs a process including:
acquiring a captured biometric image; and
outputting, upon detecting that the acquired biometric image corresponds to biometric information of a specific body part of a specific living body, medical information registered in association with the specific body part of the specific living body.
